(19) United States
(12) Patent Application Publication
(10) Pub. No.: US 2024/0056153 A1
(43) Pub. Date: Feb. 15, 2024

(54) CSI REPORTING SUBBAND GRANULARITY CONFIGURATION IN FULL DUPLEXING

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US); Ahmed Attia ABOTABL, San Diego, CA (US); Yan ZHOU, San Diego, CA (US)

(21) Appl. No.: 18/360,774

(22) Filed: Jul. 27, 2023

Related U.S. Application Data
(60) Provisional application No. 63/371,012, filed on Aug. 10, 2022.

(51) Int. Cl. H04B 7/06; H04L 5/14

(52) U.S. Cl. CPC H04B 7/0626; H04L 5/14

(57) ABSTRACT

Aspects are provided which allow a network entity to configure and a UE to transmit subband CSI reports in full duplex slots. Initially, the UE receives a CSI report configuration indicating a plurality of CSI subbands of at least one bandwidth part BWP. Subsequently, the UE receives a CSI-RS in a slot associated with a full duplex mode, the slot being further associated with a frequency band including a downlink subband and an uplink subband. Afterwards, the UE transmits a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

### CROSS-REFERENCE TO RELATED APPLICATION

This application claims the benefit of U.S. Provisional Application No. 63/371,012, filed on Aug. 10, 2022, which is hereby incorporated by reference in its entirety.

### TECHNICAL FIELD

The present disclosure relates to wireless communication, and more particularly, to managing channel state information (CSI) subbands and reporting in full duplex communication scenarios.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to receive a channel state information (CSI) report configuration indicating a plurality of CSI subbands of at least one bandwidth part (BWP), receive a CSI reference signal (CSI-RS) in a slot associated with a full duplex mode, the slot being further associated with a frequency band including a downlink subband and an uplink subband, and transmit a CSI report. The CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to transmit a CSI report configuration indicating a plurality of CSI subbands of at least one BWP, transmit a CSI-RS in a slot associated with a full duplex mode, the slot being further associated with a frequency band including a downlink subband and an uplink subband, and receive a CSI report. The CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Another innovative aspect of the subject matter described in this disclosure may be implemented in a method of wireless communication at a UE. The method includes receiving a CSI report configuration indicating a plurality of CSI subbands of at least one BWP, receiving a CSI-RS in a slot associated with a full duplex mode, the slot being further associated with a frequency band including a downlink subband and an uplink subband, and transmitting a CSI report. The CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Another innovative aspect of the subject matter described in this disclosure may be implemented in a method of wireless communication at a network entity. The method includes transmitting a CSI report configuration indicating a plurality of CSI subbands of at least one BWP, transmitting a CSI-RS in a slot associated with a full duplex mode, the slot being further associated with a frequency band including a downlink subband and an uplink subband, and receiving a CSI report. The CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A-4C illustrate examples of full-duplex communication.

FIGS. 5A-5C illustrates different examples of UEs and base stations communicating in full duplex scenarios.

FIG. 6 illustrates an example of a frequency resource allocation for a downlink transmission.

FIG. 7 illustrates an example of different approaches for frequency resource allocation in sub-band frequency division duplexing (SBFD).

FIG. 8 illustrates another example of an allocation of frequency resources for SBFD.

FIG. 9 illustrates a further example of an allocation of frequency resources for SBFD.

FIG. 10 is an additional example of an allocation of frequency resources for SBFD.

FIG. 11 is an example of a downlink and uplink slot format (a ‘D+U’ slot).

FIG. 12 illustrates another example of an allocation of frequency resources for SBFD.

FIG. 13 illustrates a further example of an allocation of frequency resources for SBFD.

FIG. 14 is a call flow diagram between a UE and a base station.

FIG. 15 is a flowchart of a method of wireless communication at a UE.

FIG. 16 is a flowchart of a method of wireless communication at a network entity.

FIG. 17 is a diagram illustrating an example of a hardware implementation for an example apparatus.

FIG. 18 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the subject matter described in this disclosure relate to wireless communication and more particularly to enhanced channel state information (CSI) reporting in full duplex scenarios, such as in-band full duplex (IBFD) and sub-band frequency division duplex (SBFD). In these scenarios, a user equipment (UE) may receive a CSI report configuration indicating a plurality of CSI subbands of at least one bandwidth part (BWP). The UE may also receive a CSI reference signal (CSI-RS) in a slot associated with a full duplex mode, which includes a frequency band with a downlink subband and an uplink subband. The UE then transmits a CSI report that includes CSI associated with the CSI-RS for a first CSI subband overlapping in frequency with the downlink subband, while the CSI report lacks CSI for a second CSI subband overlapping in frequency with the uplink subband.

In some examples, the second CSI subband overlaps in frequency with the uplink subband and a guard band between the downlink subband and the uplink subband. In some examples, the CSI report further lacks third CSI for a third CSI subband partially overlapping in frequency with the uplink subband or the guard band between the downlink subband and the uplink subband. In some examples, a third CSI subband partially overlaps in frequency with the uplink subband or a guard band between the downlink subband and the uplink subband, and the CSI report includes third CSI for a portion of the third CSI subband which overlaps with the downlink subband. In some examples, the granularity of the CSI subbands is based on a BWP size or a downlink subband size. In some examples, the at least one BWP includes a single active BWP in the frequency band, and the BWP size is of the single active BWP. In some examples, the at least one BWP includes a first active BWP and a second active BWP in the frequency band, with different groups of CSI subbands within the respective active BWPs, and the granularity of the CSI subbands is based on the BWP sizes of the respective active BWPs. The granularity of the CSI subbands may also be based on a duplex mode of the CSI report. In some examples, the initial resource block for the CSI subbands is based on a reference resource block associated with a component carrier including the at least one BWP. In some examples, the frequency band includes a second downlink subband, and the CSI subbands are defined with respect to different reference resource blocks for different downlink subbands.

Particular aspects of the subject matter described in this disclosure can be implemented to realize one or more of the following potential advantages. The enhanced handling of CSI reporting in full duplex communication scenarios may lead to improved wireless communication performance. By selectively reporting CSI for CSI subbands overlapping with downlink subbands and excluding CSI for CSI subbands overlapping with uplink subbands, the accuracy and efficiency of the CSI report can be improved. For example, by focusing on the downlink subbands, the UE may provide more relevant and precise channel information to the base station, which may then make better decisions regarding resource allocation and scheduling. This approach also helps to minimize interference, since the base station may allocate resources more effectively based on the accurate CSI reports and avoid potential conflicts between uplink and downlink transmissions. This approach also allows for better utilization of the available frequency resources, since the UE may save processing power and reduce the overhead associated with generating and transmitting unnecessary CSI reports by not reporting CSI for subbands overlapping with uplink subbands.

Moreover, the following additional potential advantages may be realized by implementing other aspects of the subject matter described in this disclosure. In one example, by considering CSI subbands that overlap in frequency with both the uplink subband and a guard band between the downlink subband and the uplink subband, the system may further improve the accuracy of the CSI report by considering the impact of the guard band on the channel conditions. In one example, by excluding CSI for subbands that partially overlap in frequency with the uplink subband or a guard band between the downlink subband and the uplink subband, the system may further reduce the overhead associated with generating and transmitting unnecessary CSI reports, leading to more efficient communication. In one example, including CSI for a portion of a subband that partially overlaps in frequency with the uplink subband or a guard band between the downlink subband and the uplink subband, and that overlaps with the downlink subband, may provide more accurate channel information for the downlink subband, improving resource allocation and scheduling decisions. In one example, including CSI for a portion of a subband that partially overlaps in frequency with the uplink subband or a guard band between the downlink subband and the uplink subband, and that overlaps with both the downlink subband and the guard band, may provide more accurate channel information for the downlink subband and the guard band, further improving resource allocation and scheduling decisions.

In one example, basing the granularity of the CSI subbands on the BWP size allows for more adaptable and flexible CSI reporting, as it can better align with the varying BWP sizes in different communication scenarios. In one example, when there is a single active BWP in the frequency band, basing the CSI subband granularity on the BWP size ensures that the CSI reporting is tailored to the specific active BWP, leading to more accurate and efficient communication. In one example, in cases where there are multiple active BWPs in the frequency band, with different BWP sizes, defining the granularity of the CSI subbands based on the respective BWP sizes allows for more accurate and efficient CSI reporting for an active BWP, improving resource allocation and scheduling decisions for a BWP. In one example, basing the granularity of the CSI subbands on both the BWP size and the downlink subband size allows for even more accurate and adaptable CSI reporting, as it considers the specific downlink subband size in addition to the BWP size.

In one example, when there is a single active BWP in the frequency band and the frequency band includes a second downlink subband, basing the granularity of the CSI subbands on the aggregate size of the downlink subbands allows for more accurate and efficient CSI reporting, as it considers the combined impact of both downlink subbands on the channel conditions. In one example, basing the granularity of the CSI subbands on the duplex mode of the CSI report allows for more adaptable and flexible CSI reporting, as it can better align with the varying duplex modes in different communication scenarios. In one example, when the CSI report configuration indicates both a half-duplex subband size and a full-duplex subband size, basing the granularity of the CSI subbands on the full-duplex subband size when the duplex mode is full-duplex ensures that the CSI reporting is tailored to the specific duplex mode, leading to more accurate and efficient communication. In one example, basing the initial resource block for the CSI subbands on a reference resource block associated with a component carrier including the BWP ensures that the CSI subbands are aligned with the component carrier, leading to more accurate and efficient CSI reporting. In one example, when the frequency band includes a second downlink subband, defining the initial resource block for the CSI subbands associated with different downlink subbands based on different reference resource blocks allows for more accurate and efficient CSI reporting for a downlink subband, improving resource allocation and scheduling decisions for the downlink subband.

Time division duplexing (TDD) deployments and frequency division duplexing (FDD) deployments may be half-duplex or full-duplex. In half-duplex communication, a base station or UE may transmit and receive data at different times, but not at the same time. In contrast, in full-duplex communication, a base station or UE may transmit and receive data at the same time. One example of full-duplex communication is IBFD, in which a base station or UE may transmit and receive data in at least part of (or all of) the same frequency resource(s). Another example of full-duplex communication is sub-band FDD (SBFD, also referred to as flexible duplex), in which a base station or UE may transmit and receive data in different frequency resources.

Half duplex or full duplex UEs may communicate with full duplex base stations using SBFD or IBFD. In either SBFD or IBFD, downlink frequency resources and uplink frequency resources may occupy different subbands of a frequency band. To enhance communications in such scenarios, it would be helpful for these UEs to apply CSI measurement and reporting in such subbands.

However, conventional CSI configurations do not address CSI subband reporting in connection with full duplex communication. Although conventional CSI report configurations provide for aligned FDRA and subband CSI reporting in half-duplex scenarios, it would be helpful to extend these configurations for full-duplex scenarios (e.g., SBFD or IBFD) including multiple downlink subbands separated by an uplink subband. Moreover, it would be helpful to define the frequency domain granularity of such downlink subbands in terms of resource block groups (RBGs) or physical resource blocks (PRBs) for full-duplex scenarios, since the subband CSI reporting may depend on the granularity of the downlink subbands. Additionally, it would be helpful to define the CSI subbands in connection with SBFD or other full duplexing scenarios.

Accordingly, aspects of the present disclosure allow for CSI subband reporting in connection with full duplex communication. In one aspect, CSI subbands may be defined in multiple manners based on an associated frequency division resource assignment (FDRA) for a full duplex slot. In another aspect, a frequency domain granularity of CSI subbands may be defined in multiple manners for full duplex slots (e.g., SBFD slots). In a further aspect, different frequency domain granularities may be defined for CSI subbands associated with different slot types or duplex modes (e.g., a full duplex slot, a half-duplex slot, or a slot including full duplex symbols and half duplex symbols). In an additional aspect, a reference resource block (a PRB) indicating the initial reference point for CSI subbands may be defined in different manners for full duplex scenarios. Examples of these and other aspects will be subsequently described in connection with the aforementioned Figures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

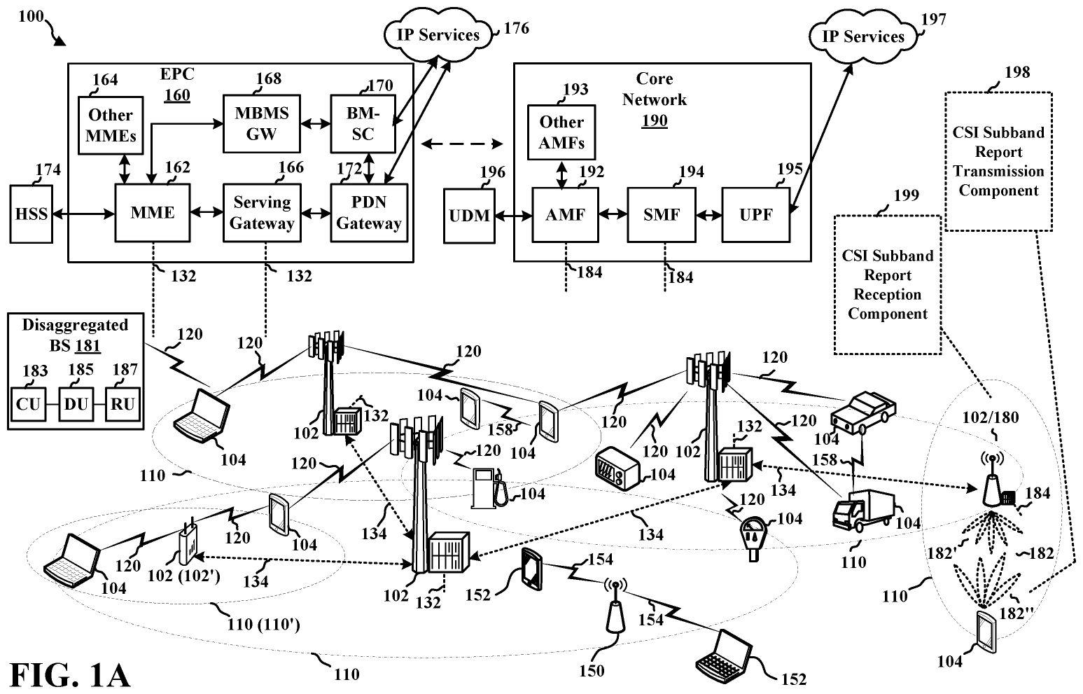

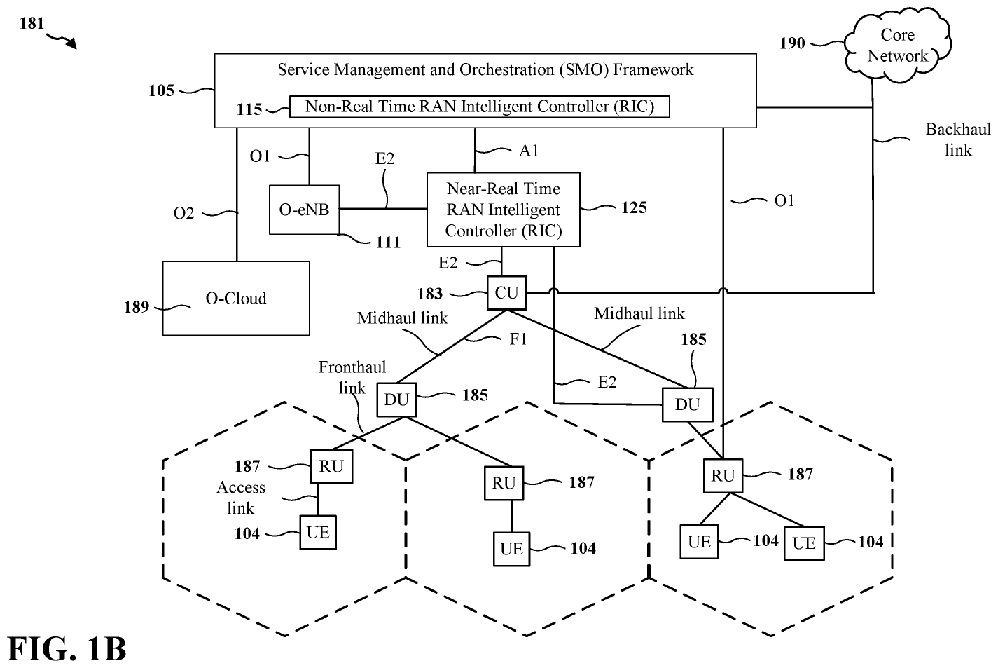

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a CSI subband report transmission component 198 that is configured to receive a channel state information (CSI) report configuration indicating a plurality of CSI subbands of at least one bandwidth part (BWP), receive a CSI reference signal (CSI-RS) in a slot associated with a full duplex mode, the slot being further associated with a frequency band including a downlink subband and an uplink subband, and transmit a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband. Furthermore, in certain aspects, a network entity such as base station 102/180, disaggregated base station 181, or a component of disaggregated base station 181 such as CU 183, DU 185, or RU 187, may include a CSI subband report reception component 199 that is configured to transmit a CSI report configuration indicating a plurality of CSI subbands of at least one BWP, transmit a CSI-RS in a slot associated with a full duplex mode, the slot being further associated with a frequency band including a downlink subband and an uplink subband, and receive a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

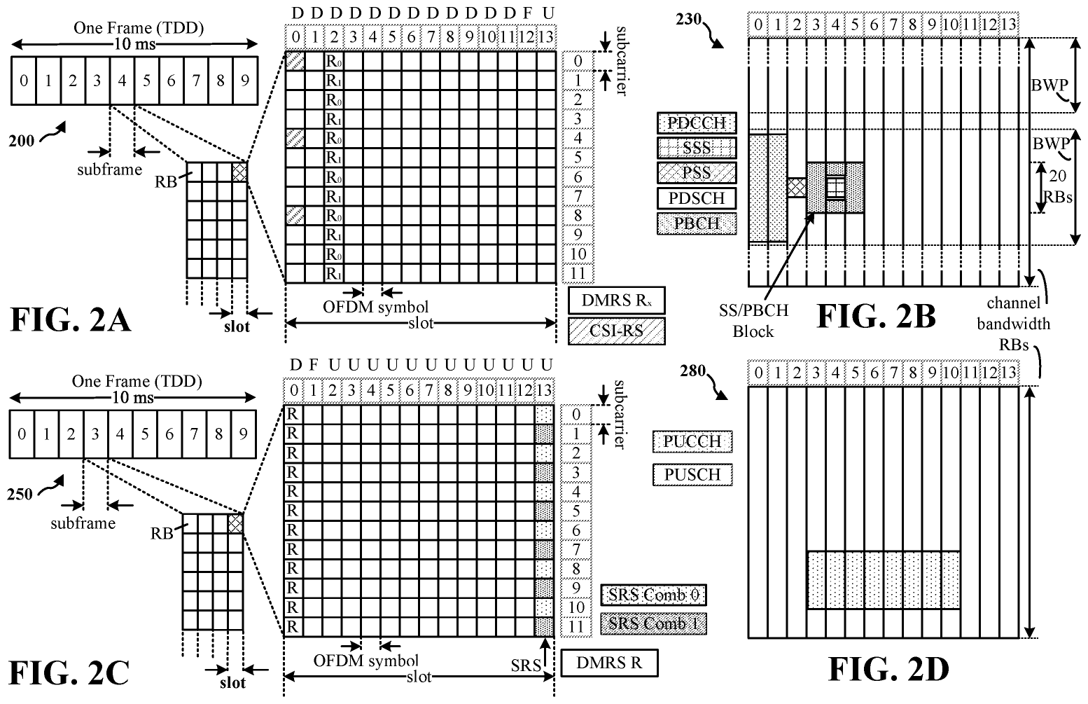

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

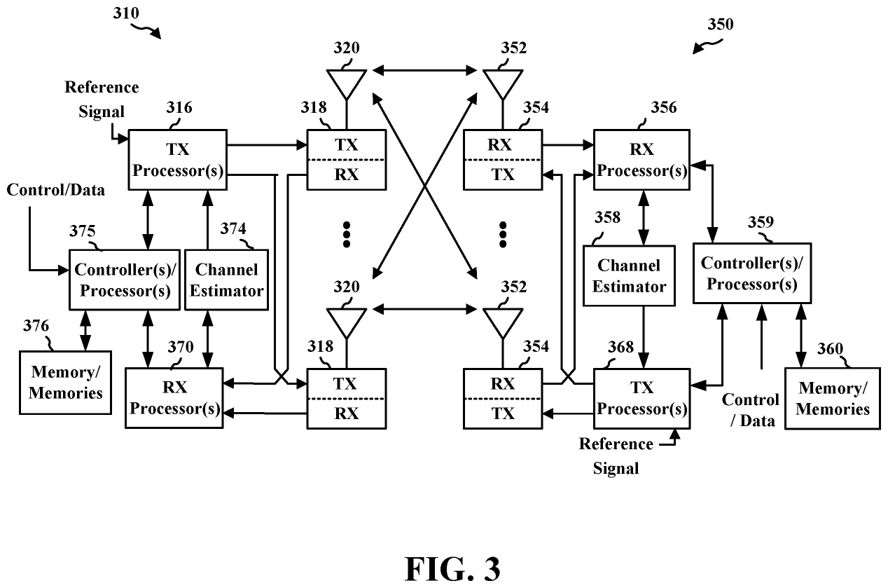

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with CSI subband report transmission component 198 of FIG. 1A.

At least one of the one or more TX processors 316, the one or more RX processors 370, and the one or more controller/processors 375 may be configured to perform aspects in connection with CSI subband report reception component 199 of FIG. 1A.

TDD deployments and FDD deployments may be half-duplex or full-duplex. In half-duplex communication, a base station or UE may transmit and receive data at different times, but not at the same time. In contrast, in full-duplex communication, a base station or UE may transmit and receive data at the same time.

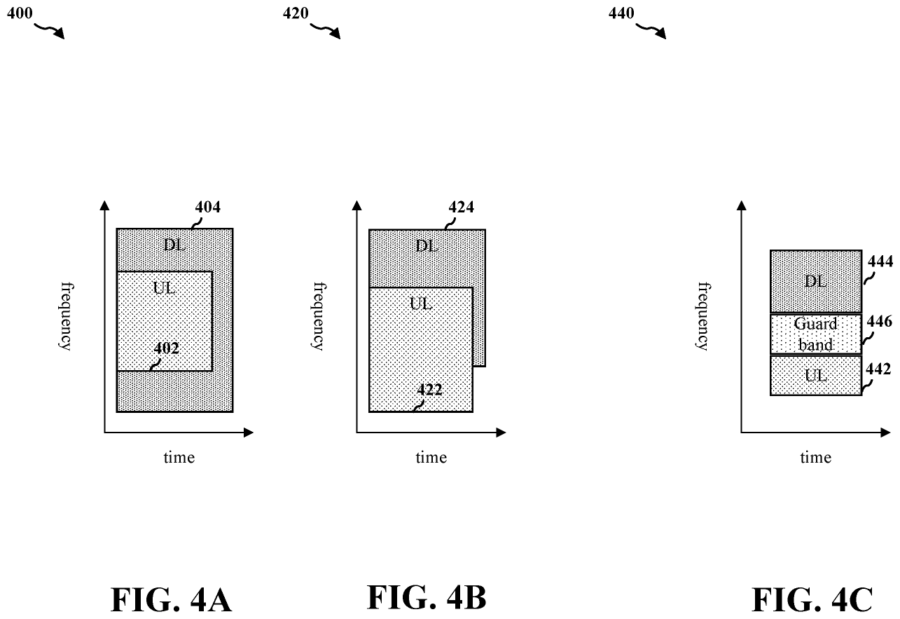

FIGS. 4A-4C illustrate examples 400, 420, 440 of full-duplex communication. FIGS. 4A and 4B refer to different examples of in-band full duplex (IBFD), in which a base station or UE may transmit and receive data in at least part of (or all of) the same frequency resource(s). For instance, in the example 400 of FIG. 4A, uplink frequency resources 402 may completely overlap with downlink frequency resources 404, while in the example 420 of FIG. 4B, uplink frequency resources 422 may partially overlap with downlink frequency resources 424. Moreover, FIG. 4C illustrates another example of full-duplex communication, namely sub-band FDD (SBFD, also referred to as flexible duplex), in which a base station or UE may transmit and receive data in different frequency resources. For instance, in the example 440 of FIG. 4C, uplink frequency resources 442 and downlink frequency resources 444 may be separated by a guard band 446 in the frequency domain to minimize interference between the uplink and downlink frequency resources.

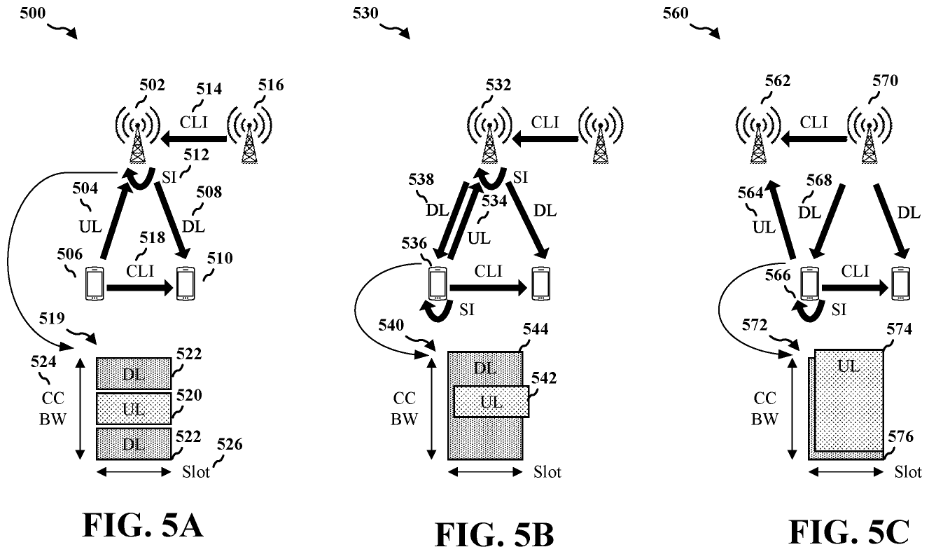

FIGS. 5A-5C illustrates different examples 500, 530, 560 of full duplex scenarios (e.g., SBFD or IBFD). In the example 500 of FIG. 5A, a base station 502 capable of full duplex communication may receive an uplink transmission 504 from a first UE 506 at the same time that the base station provides a downlink transmission 508 to a second UE 510. The first UE and second UE may not be capable of full duplex communication in this example (e.g., they are half-duplex UEs). This scenario may result in self-interference (SI) 512 at the base station 502, cross link interference (CLI) 514 between the base station 502 and a neighbor base station 516, and CLI 518 between the first UE 506 and the second UE 510. To minimize this interference, SBFD 519 may be applied in which uplink frequency resources 520 for the uplink transmission 504 are separated from downlink frequency resources 522 for the downlink transmission 508 in a frequency band 524 (e.g., a component carrier (CC) bandwidth) and a slot 526.

While in the example of FIG. 5A, the first UE 506 and the second UE 510 operate in a half-duplex mode (e.g., the UEs are not capable of full duplex communication), in other examples, the UEs may be capable of full duplex communication. For instance, in the example 530 of FIG. 5B, a base station 532 capable of full duplex communication (similar to base station 502) may receive an uplink transmission 534 from a UE 536 at the same time that the base station provides a downlink transmission 538 to the UE 536. Similarly, in the example 560 of FIG. 5C, a base station 562 or first transmission-reception point (TRP) may receive an uplink transmission 564 from a UE 566 at the same time that the UE 566 obtains a downlink transmission 568 from a neighbor base station 570 or second TRP.

In the illustrated examples of FIGS. 5B and 5C, different examples of IBFD may be applied for the uplink and downlink communications. For instance, as illustrated in the example 530 of FIG. 5B, IBFD 540 may be applied in which uplink frequency resources 542 for the uplink transmission 534 partially overlap with downlink frequency resources 544 for the downlink transmission 538. Similarly, as illustrated in the example 560 of FIG. 5C, IBFD 572 may be applied in which uplink frequency resources 574 for the uplink transmission 564 may partially overlap with downlink frequency resources 576 for the downlink transmission 568.

While the examples of FIGS. 5A-5C respectively apply SBFD, one example of IBFD (partial overlap), and another example of IBFD (partial overlap), these examples are not limited to such full duplex scenarios. For instance, IBFD may alternatively be applied in the example of FIG. 5A. Conversely, SBFD may alternatively be applied in the example of FIG. 5B or in the example of FIG. 5C.

Thus, half duplex or full duplex UEs may communicate with full duplex base stations using SBFD or IBFD. In either SBFD or IBFD, as illustrated in FIGS. 5A-5C, downlink frequency resources and uplink frequency resources may occupy different subbands of a frequency band (e.g., frequency band 524). For instance, in the example of FIGS. 5A and 5B, an uplink subband including the uplink frequency resources 520, 542 may separate multiple downlink subbands including the downlink frequency resources 522, 544. To enhance communications in such scenarios, it would be helpful for these UEs to apply CSI measurement and reporting in such subbands. However, conventional CSI configurations do not address CSI subband reporting in connection with full duplex communication.

Currently, a base station may configure a UE to provide wideband CSI reporting or subband CSI reporting. For instance, the base station may provide a CSI report configuration indicating a wideband reporting granularity or a subband reporting granularity. In wideband CSI reporting, a UE may provide a report indicating CSI (e.g., CQI or PMI) associated with a CSI measurement resource for an entire frequency band. In subband CSI reporting, a UE may provide a report respectively indicating CSI (e.g., CQI or PMI) associated with a CSI measurement resource for respective subbands of the frequency band. These subbands are referred to throughout this disclosure as CSI subbands, and a respective CSI subband includes a quantity of contiguous PRBs.

In subband CSI reporting, the granularity of a CSI subband (the subband size) relates to the size of the BWP including the CSI subbands. Currently, different subband sizes are defined based on the BWP size such that the maximum number of CSI subbands does not exceed 19. These subband sizes are also defined to be compatible with (integer multiples of) typical granularities associated with precoding (a PRB size, generally 2 or 4 PRBs) and frequency allocation (a resource block group (RBG) size) in PDSCH to avoid misalignment. An example of various subband sizes configurable for different ranges of BWP sizes is shown in Table 1, where for CSI reporting, a UE may be configured via higher layer signaling with one out of two possible subband sizes depending on the total number of PRBs in the BWP:

TABLE 1
Configurable Subband Sizes

| BWP (PRBs) | Subband Size (PRBs) |
|---|---|
| 24-72 | 4, 8 |
| 73-144 | 8, 16 |
| 145-275 | 16, 32 |

The frequency domain resource assignment (FDRA) for a CSI measurement resource in PDSCH (as well as for uplink data in PUSCH) may be allocated in two different manners. In one type of resource allocation, referred to as Type 1 resource allocation, the base station allocates consecutive RBs indicated in a resource indicator value (RIV). In another type of resource allocation, referred to as Type 0 resource allocation, the base station configures a bitmap which defines the frequency resources based on RBG size. An example of various RBG sizes configurable for different ranges of BWP sizes is shown in Table 2, where a UE may be configured with one out of two possible RBG sizes depending on the BWP size and a configuration type (1 or 2). A comparison of Table 1 and Table 2 may show that CSI subband sizes are multiples of associated RBG sizes.

TABLE 2
Nominal RBG Size

| BWP Size (PRBs) | Configuration 1 | Configuration 2 |
|---|---|---|
| 1-36 | 2 | 4 |
| 37-72 | 4 | 8 |
| 73-144 | 8 | 16 |
| 144-275 | 16 | 16 |

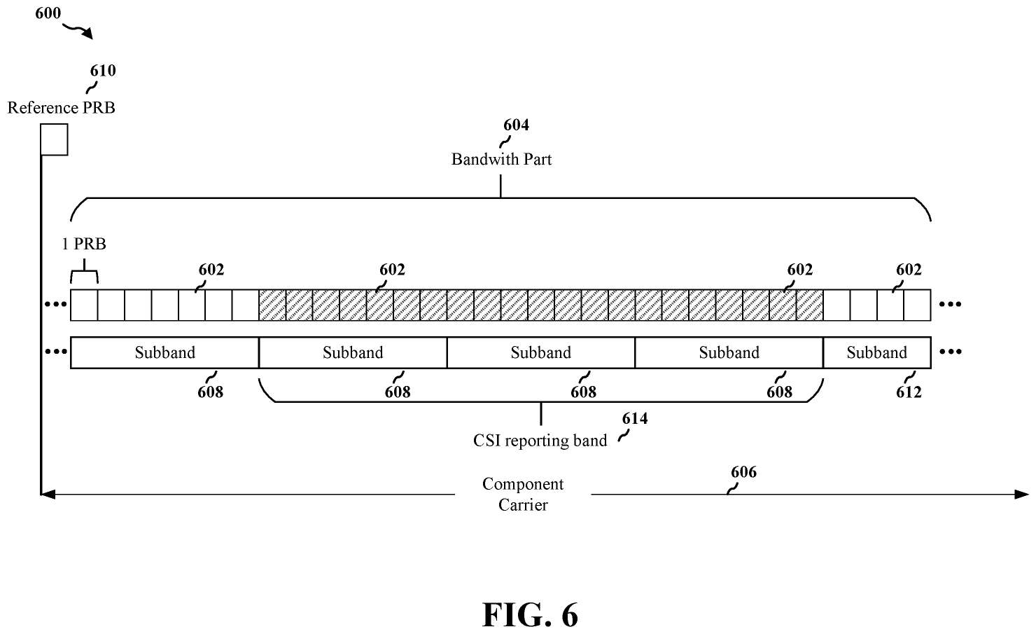

FIG. 6 illustrates an example 600 of a frequency resource allocation for a downlink transmission. While the illustrated example shows frequency resources 602 being defined in terms of PRB s, in an alternative example, the frequency resource allocation may be defined in terms of RBGs. The frequency resources 602 are allocated in a BWP 604 of a component carrier 606 (e.g., frequency band 524 of FIG. 5A), and CSI subbands 608 of a particular subband size are respectively defined from contiguous quantities of the frequency resources 602 based on the size of BWP 604. To maintain alignment between the FDRA and subband CSI reporting, the frequency resources 602 (e.g., PRBs or RBGs) and CSI subbands 608 are both defined with respect to a reference resource block 610 for the component carrier 606, rather than with respect to an initial resource block for the BWP 604. As a result, the BWP 604 may include a CSI subband smaller in size than the configured subband size at either or both edges of the BWP, referred to throughout this disclosure as an edge CSI subband 612. The UE may report CSI respectively for CSI subbands 608 within a CSI reporting band 614. The CSI report configuration indicates the CSI reporting band 614, which in turn indicates the defined CSI subbands to be included in the CSI report. For instance, the CSI report configuration may indicate a quantity of CSI subbands (in a parameter csi-ReportingBand or some other name). Currently, the configurable quantities range from at least three CSI subbands to at most nineteen CSI subbands, corresponding to the maximum quantity of CSI subbands that can be reported. For a configured quantity of CSI subbands, a bitmap defines which of the CSI subbands 608 are part of the CSI reporting band 614, where a value of ‘1’ indicates the CSI subband is part of the CSI reporting band, while a value of ‘0’ indicates the CSI subband is excluded from the CSI reporting band (or vice-versa). For instance, in the example 600 of FIG. 6, the CSI report configuration indicates a quantity of five CSI subbands (via parameter subbands5 in csi-ReportingBand or another name) with a bitmap of ‘01110’ (the value of subbands5) to indicate that the UE is to report CQI or PMI for each of the middle three CSI subbands (the CSI subbands in CSI reporting band 614) but not for the two outermost CSI subbands.

Although conventional CSI report configurations provide for aligned FDRA and subband CSI reporting in half-duplex scenarios, it would be helpful to extend these configurations for full-duplex scenarios (e.g., SBFD or IBFD) including multiple downlink subbands separated by an uplink subband. In one approach, a single BWP may be activated that spans the multiple downlink subbands (e.g., the downlink subbands are defined based on a configured RB-set). In another approach, multiple BWPs may be activated that respectively are mapped to a different downlink subband (e.g., the downlink subbands are respectively defined based on BWP). Here, a respective downlink subband may include one RB or a set of consecutive RBs.

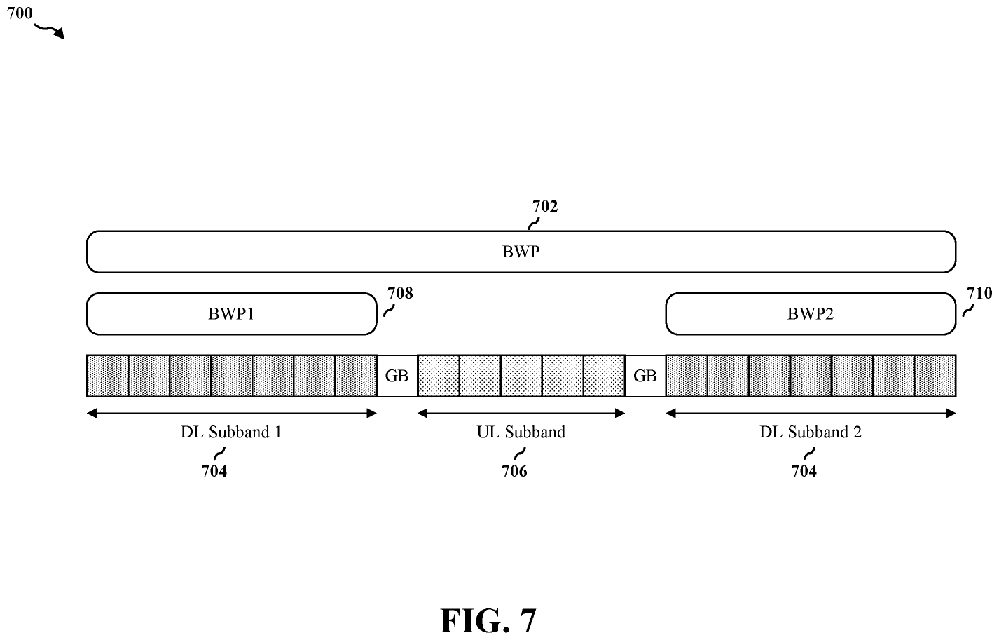

FIG. 7 illustrates an example 700 of the aforementioned different approaches for frequency resource allocation in SBFD. In one example, a single BWP 702 may be configured or activated to span multiple downlink subbands 704. In this example, an uplink subband 706 separating the downlink subbands 704 may be contained within the single BWP 702. In another example, multiple BWPs may be configured or activated to respectively span the multiple downlink subbands 704. For instance, a first BWP 708 may span one of the downlink subbands 704 while a second BWP 710 may span another one of the downlink subbands 704. In this example, the uplink subband 706 may not be contained within an active BWP.

It would be helpful to define the frequency domain granularity of such downlink subbands in terms of RBGs (for Type 0 resource allocation) or PRBs (for Type 1 resource allocation) for full-duplex scenarios, since the subband CSI reporting may depend on the granularity of the downlink subbands. In one approach, full-duplex slots or symbols may be configured with the same RBG or PRB resource allocation as half-duplex slots or symbols. In such case, to differentiate FDRA for both types of duplex modes, an FDRA for half-duplex slots or symbols may be interpreted differently than an FDRA for full-duplex slots or symbols (e.g., the UE may interpret a bitmap in Type 0 resource allocation differently between the two duplex modes). In another approach, full-duplex slots or symbols may be configured with a different RBG or PRB resource allocation than that of half-duplex slots or symbols. In a further approach, different downlink subbands of a frequency band may be configured with different RBG or PRB resource allocations.

Additionally, it would be helpful to define the CSI subbands in connection with SBFD or other full duplexing scenarios. For instance, CSI subbands of a certain subband size may be defined with respect to a reference resource block of a component carrier to maintain alignment with FDRA. However, such definition of CSI subbands may lead to full or partial overlap with uplink subbands or guard bands, thus resulting in edge CSI subbands overlapping with downlink subbands. Edge CSI subbands may result in inaccurate channel estimates for subband CSI reporting due to edge subbands' smaller sizes with respect to configured CSI subband sizes. For example, even though the channel qualities between a CSI subband and an edge CSI subband may not be significantly different, the UE may nevertheless determine different CQIs for the smaller edge CSI subband than for the other larger CSI subband, due to shorter channel averaging in the edge CSI subband. It would therefore be helpful to define how to manage such edge CSI subbands, as well as to manage guard bands and CSI subband granularity in view of downlink subband granularity.

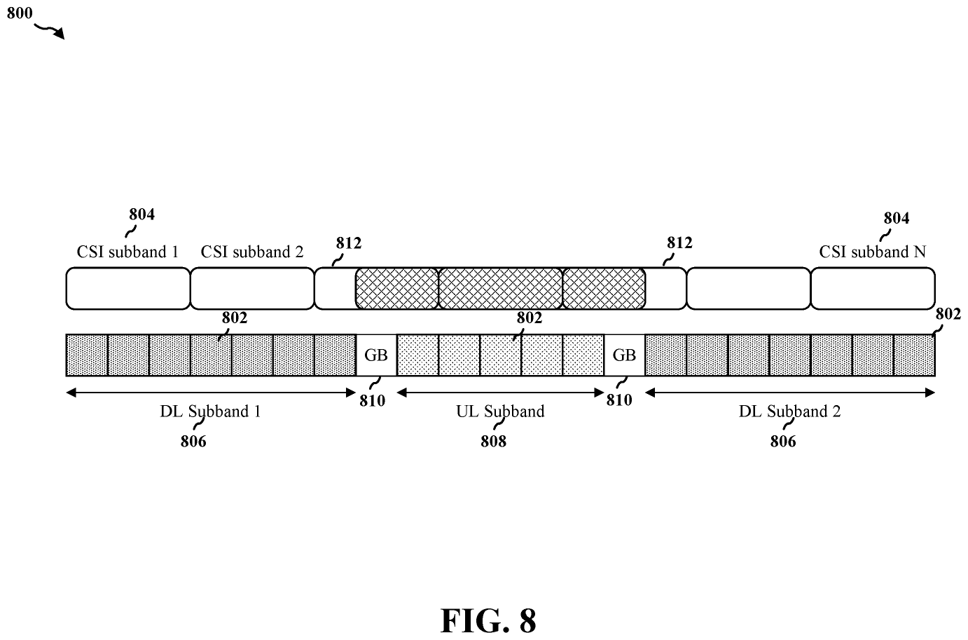

FIG. 8 illustrates an example 800 of an allocation of frequency resources 802 for SBFD. Similar to that of example 600 in FIG. 6, CSI subbands 804 of a particular subband size are respectively defined from contiguous quantities of the frequency resources 802. Moreover, similar to that of example 700 of FIG. 7, multiple downlink subbands 806, an uplink subband 808 separating the downlink subbands 806, and a guard band 810 separating a respective downlink subband from the uplink subband 808, may be allocated in SBFD. As a result, the CSI subbands 804 may overlap with the uplink subband 808 and guard bands 810, resulting in edge CSI subbands 812 which are smaller in size than CSI subbands 804. Therefore, it would be helpful at least to define how to manage the edge CSI subbands 812, guard bands 810, and the frequency domain granularity of CSI subbands 804, in SBFD or other full duplexing scenarios.

In one aspect, CSI subbands may be defined in multiple manners based on an associated FDRA (e.g., a CSI-RS bandwidth) for a full duplex slot including downlink subbands, an uplink subband, and guard bands. In a first example, CSI subbands that are contained in (overlap with) uplink subbands and guard bands are deactivated in the CSI report configuration. In a second example, CSI subbands that partially overlap with uplink subbands and guard bands remain activated in the CSI report configuration but may be handled in various manners for CSI reporting. For instance, in the first example, the CSI report configuration may indicate that the CSI subbands which overlap with uplink subbands and guard bands are not part of the CSI reporting band (e.g., via a bit of ‘0’ in the relevant subband parameter in csi-ReportingBand), thus restricting CSI reporting only for CSI subbands overlapping with the downlink subbands. In contrast, in the second example, the CSI report configuration may still indicate these overlapping CSI subbands are part of the CSI reporting band (e.g., via a bit of ‘1’ in the relevant subband parameter in csi-ReportingBand), and thus the CSI reporting is not restricted like in the first example, but here the UE may refrain from including these activated CSI subbands in its CSI report according to various options.

In a first option of the second example, the UE may drop such overlapping CSI subbands entirely from the CSI report. In a second option of the second example, the UE may not drop such CSI subbands entirely from the CSI report, but instead, the UE may truncate such CSI subbands to form edge CSI subbands and include those edge CSI subbands in the CSI report. In one example of this truncation, the UE may form edge CSI subbands overlapping solely with downlink subbands as a result of the truncation. In another example of this truncation, the UE may form edge CSI subbands overlapping with both downlink subbands and guard bands as a result of the truncation. Such edge CSI subbands overlapping with guard bands may allow for a UE to perform interference measurement of CSI-IM in the guard bands.

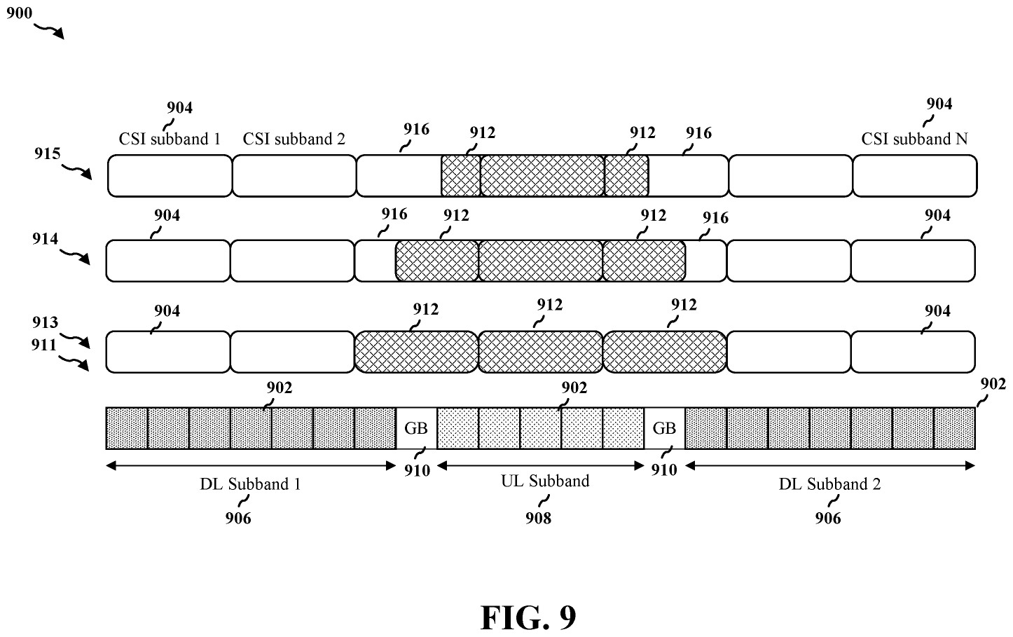

FIG. 9 illustrates an example 900 of an allocation of frequency resources 902 for SBFD. Similar to that of example 800 in FIG. 8, CSI subbands 904 of a particular subband size are respectively defined from contiguous quantities of the frequency resources 902, and multiple downlink subbands 906, an uplink subband 908 separating the downlink subbands 906, and a guard band 910 separating a respective downlink subband from the uplink subband 908, may be allocated in SBFD. As a result, the CSI subbands 904 may overlap with the uplink subband 908 and guard bands 910. In a first example 911 of such case, the base station may ignore, in the CSI report configuration, entire CSI subbands 912 that overlap, whether fully or partially, with the uplink subband 908 and guard bands 910. Thus, the definition of CSI subbands may be restricted to those fully overlapping with downlink subbands 906; these CSI subbands may not overlap even partially with uplink subband 908 or guard bands 910. In second example of such case, the base station may include the overlapping CSI subbands in the CSI report configuration, but the UE may refrain from applying these CSI subbands in its CSI report according to various options. In a first option of this second example, referred to as example 913, the UE may be configured to drop the entire CSI subbands 912 from its CSI report. As a result, in either the first example or first option of the second example, edge CSI subbands in the middle of the BWP or between multiple BWPs, such as edge CSI subbands 812 of FIG. 8, will not be present since the entire CSI subband 912 is ignored due to the overlap. In contrast, edge CSI subbands at the beginning or end of the BWP(s), such as edge CSI subband 612 of FIG. 6, may still remain. In a second option of the second example, the UE may be configured to truncate CSI subbands 904 that overlap partially with the uplink subband 908 and guard bands 910 to form edge CSI subbands 916 and include the edge CSI subbands 916 in its CSI report. In one example 914 of the second option, the edge CSI subbands 916 may overlap solely with the downlink subbands 906. In another example 915 of the second option, the edge CSI subbands 916 may overlap with both the downlink subbands 906 and the guard bands 910.

In another aspect, a frequency domain granularity of CSI subbands may be defined in multiple manners for full duplex slots (e.g., SBFD slots). In a first example, the granularity of a CSI subband for full duplex slots may depend on BWP size. For instance, the granularity of CSI subbands may be a multiple of a PDSCH precoding granularity (e.g., 2 or 4 PRBs) and a PDSCH frequency resource allocation granularity (e.g., 2, 4, 8, or 16 RBGs, depending on the BWP size), such that a maximum of 19 subbands may be configured. In one option for the first example, downlink subbands in a full duplex slot may be defined as respective RB-sets, and thus a single BWP may contain multiple downlink subbands. In this option, the size of a respective downlink subband may not impact CSI subband granularity, since only BWP size is the relevant factor. In another option for the first example, respective downlink subbands in a full duplex slot may be defined in different active BWPs. Here, the BWPs may have different sizes and respectively correspond to a single downlink subband. In this option, the CSI subband granularities respectively associated with the multiple active BWPs may be different. Thus, different downlink subbands may be associated with different frequency domain granularities for subband CSI reporting, and a single CSI report may include CSI associated with CSI subbands of different frequency domain granularities for different BWP sizes.

In a second example, the granularity of a CSI subband for full duplex slots may depend not only on a size of a BWP, but also on the size of a downlink subband in that BWP. In one example, the downlink subbands of a full duplex slot may be respectively defined by RB sets within a single active BWP, in which case the CSI subbands overlapping with the uplink subband and guard subbands of the full duplex slot may be ignored (e.g., only CSI subbands spanning downlink subbands are included in the CSI report). In such case, the CSI subband granularity may be based on an aggregate size of the multiple downlink subbands, allowing for the network to support a finer frequency domain granularity while maintaining the limit on CSI subbands to not exceed 19.

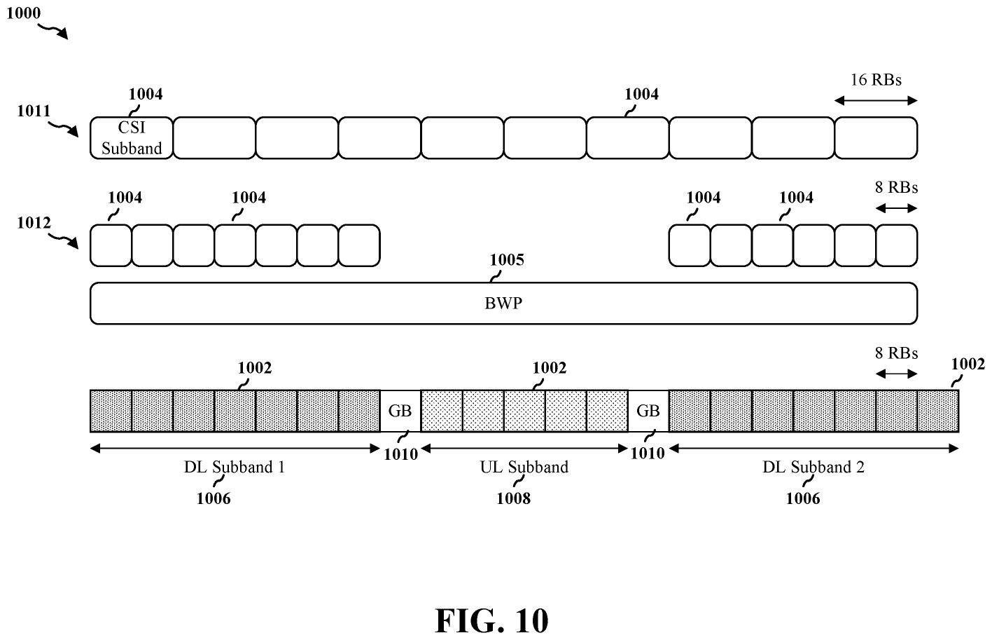

FIG. 10 is an example 1000 of an allocation of frequency resources 1002 for SBFD. Similar to that of example 900 in FIG. 9, CSI subbands 1004 of a particular subband size in a BWP 1005 may be respectively defined from contiguous quantities of the frequency resources 1002, and multiple downlink subbands 1006, an uplink subband 1008 separating the downlink subbands 1006, and a guard band 1010 separating a respective downlink subband from the uplink subband 1008, may be allocated in SBFD. In one example 1011, the granularity or size of CSI subbands 1004 may be defined based on a size of the BWP 1005. For instance, if the size of the BWP 1005 is 160 PRBs, then according to Table 1 above, the granularity of respective CSI subbands in the entire BWP may be 16 RBs or 32 RBs. Thus, in the example 1011 illustrated in FIG. 10, one example of the CSI subband size may be 16 RBs, notwithstanding the respective sizes of the downlink subbands 1006. In another example 1012, the granularity or size of the CSI subbands 1004 may be defined further based on a size of the downlink subbands 1006 as well as the size of the BWP 1005. Thus, in this example, the size of the uplink subband 1008 and the size of the guard bands 1010 may be excluded in the subband size determination. For instance, in the example 1012 illustrated in FIG. 10 where the size of BWP 1005 is 160 PRBs, here the aggregate size of the multiple downlink subbands 1006 in BWP 1005 may be 104 PRBs (13*8 RBs), and thus according to Table 1 above, the granularity of respective CSI subbands overlapping solely with the downlink subbands 1006 may be 8 RBs or 16 RBs. Thus, in the example 1012 illustrated in FIG. 10, another example of the CSI subband size may be 8 RBs, based on the aggregate size of the downlink subbands 1006. As a result, a finer CSI subband granularity (e.g., 8 RBs in example 1012 vs. 16 RBs in example 1011) may be obtained if downlink subband size is considered to be a factor in subband size determination. In either example, notwithstanding whether a coarser granularity or finer granularity is obtained for the CSI subband.

In a further aspect, different frequency domain granularities may be defined for CSI subbands associated with different slot types or duplex modes (e.g., a full duplex slot, a half-duplex slot, or a slot including full duplex symbols and half duplex symbols). As previously described, a frequency domain granularity of downlink subbands may be defined in one of multiple manners in terms of RBGs or PRBs. For instance, full-duplex slots or symbols may be configured with the same RBG or PRB resource allocation as half-duplex slots or symbols, full-duplex slots or symbols may be configured with a different RBG or PRB resource allocation than that of half-duplex slots or symbols, or different downlink subbands of a frequency band may be configured with different RBG or PRB resource allocations. In any of the foregoing examples, the CSI subband size may be aligned to (be a multiple of) the RBG size associated with a full-duplex slot or symbol. For instance, the base station may configure different RBG resource allocations between full-duplex slots and half-duplex slots such that RBG size=4 for full duplexing and RBG size=8 for half duplexing, and therefore if the BWP size is 72 PRBs, the CSI subband size in a full duplex slot may be configured as a multiple of RBG size=4 while the CSI subband size in a half-duplex slot may be configured as a multiple of RBG size=8.

Thus, the CSI subband size may be configured to be dependent on the duplex mode of an associated slot or symbol, such that different CSI subband granularities may exist respectively for half duplex slots (or symbols) and full duplex slots (or symbols). In one approach, the CSI report configuration may indicate multiple subband sizes respectively for half duplexing and full duplexing, and the multiple subband sizes may respectively be based on the RBG size associated with a respective duplex mode. For instance, in the aforementioned example where RBG size=4 for full duplexing and RBG size=8 for half duplexing, the base station may configure the CSI report configuration with one subband size from Table 1 above that is a multiple of 4 for full duplex slots or symbols, and another subband size from Table 1 above that is a multiple of 8 for half duplex slots or symbols. The half-duplex subband size may be indicated in the CSI report configuration via a parameter CSI-subband-size-HD or another name, and the full-duplex subband size may be indicated in the CSI report configuration via a parameter CSI-subband-size-FD or another name. The UE may then select which of the two indicated subband sizes to use (e.g., CSI-subband-size-HD or CSI-subband-size-FD) depending on the duplex mode of the slot or symbol associated with the CSI report.

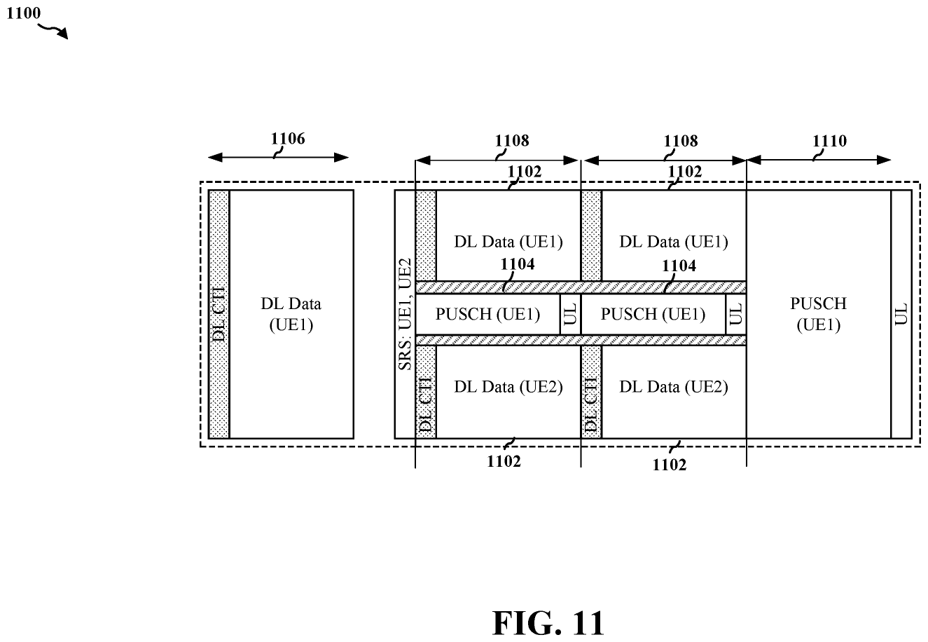

FIG. 11 is an example 1100 of a downlink and uplink slot format (a ‘D+U’ slot). A ‘D+U’ slot is a slot in which the frequency band is used for both uplink and downlink transmissions, and where the downlink and uplink transmissions may occur in overlapping bands (IBFD) or adjacent bands (SBFD). For instance, in the illustrated example of FIG. 11, the ‘D+U’ slot may include multiple downlink subbands 1102 and an uplink subband 1104. A ‘D+U’ slot may contain downlink-only symbols, uplink-only symbols, or full-duplex symbols. Moreover, in a given ‘D+U’ slot, a half-duplex UE may either transmit data in the uplink subband 1104 or receive data in one of the downlink subbands 1102 (but not both downlink and uplink simultaneously), while a full-duplex UE may transmit data in the uplink subband 1104 and/or receive data in one of the downlink subbands 1102. In periodic or semi-persistent occasions, a ‘D+U’ slot may be preceded or followed by another ‘D+U’ slot (a full-duplex slot) or a half-duplex slot. For instance, in the illustrated example of FIG. 11, downlink slot 1106 may precede ‘D+U’ slot 1108, and uplink slot 1110 may follow ‘D+U’ slot 1108. Therefore, to align CSI subband sizes with respective RBG sizes or PRB sizes in slots associated with different duplex modes, the base station may indicate multiple subband sizes in the CSI report configuration respectively for half duplexing and full duplexing, and the UE may apply one of these subband sizes depending on the applicable duplexing mode. For instance, if the CSI to be reported is based on CSI-RS received in downlink slot 1106, the UE may apply the half-duplex subband size indicated in the CSI report configuration for CSI subbands. In contrast, if the CSI to be reported is based on CSI-RS received in ‘D+U’ slot 1108, the UE may instead apply the full-duplex subband size indicated in the CSI report configuration for CSI subbands.

In an additional aspect, a reference resource block (PRB) indicating the initial reference point for CSI subbands may be defined in different manners for full duplex scenarios. As previously described, PRBs, RBGs, and CSI subbands in half duplex slots may be defined with respect to a reference resource block for a component carrier, rather than with respect to an initial resource block for the BWP. Thus, in a first example, CSI subbands in a full duplex slot, including multiple downlink subbands and an uplink subband separating the downlink subband, may be similarly defined with respect to a reference resource block in a component carrier. That is, the initial reference point for CSI subbands may be aligned with an initial PRB of the component carrier, rather than with an initial PRB of the BWP. However, due to UE disregard of CSI subbands overlapping with such uplink subbands as previously described, such definition for CSI subbands may result in edge CSI subbands (having smaller subband sizes) being formed at the edges of the downlink subbands as well as the edges of the BWP. These edge CSI subbands may result in less CSI accuracy in the CSI report due to their smaller subband size with respect to the other CSI subbands.

Therefore, to reduce the number of edge CSI subbands, in a second example, CSI subbands associated with different downlink subbands in such full duplex slots may be defined with respect to different initial reference blocks. For instance, a first group of CSI subbands overlapping with a first downlink subband may be defined with respect to a first reference resource block, while a second group of CSI subbands overlapping with a second downlink subband may be defined with respect to a second reference resource block. The first reference resource block may be defined as the reference resource block of the component carrier, and thus the first group of CSI subbands may be defined in alignment with the FDRA of the full duplex slot (e.g., the allocated PRBs or RBGs) as previously described. However, the second reference resource block may be defined as an initial resource block of the second downlink subband, and thus the second group of CSI subbands may be defined with a different timing than the first group of CSI subbands based on this different reference resource block. As a result, fewer edge CSI subbands may result in this example, improving accuracy of CSI reporting or channel estimation.

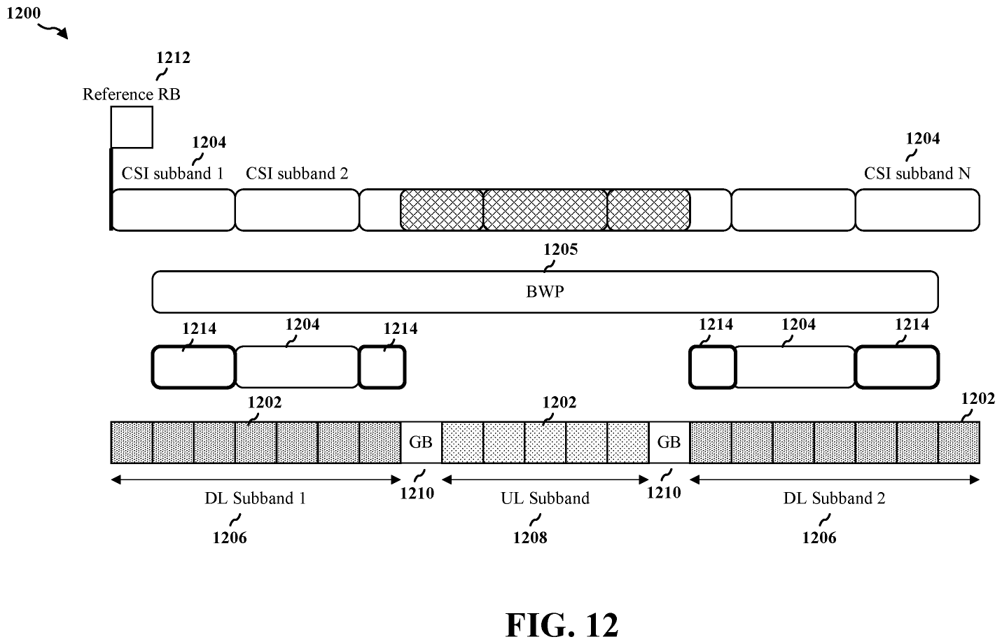

FIG. 12 illustrates an example 1200 of an allocation of frequency resources 1202 for SBFD. Similar to that of example 1000 in FIG. 10, CSI subbands 1204 in a BWP 1205 may be respectively defined from contiguous quantities of the frequency resources 1202, and multiple downlink subbands 1206, an uplink subband 1208 separating the downlink subbands 1206, and a guard band 1210 separating a respective downlink subband from the uplink subband 1208, may be allocated in SBFD. In this example, CSI subbands 1204 may be defined with respect to a reference resource block 1212 for a component carrier including the BWP 1205 to maintain alignment with or be a multiple of PDSCH precoding granularity (PRB size) and FDRA granularity (RBG size). As a result, four of the CSI subbands 1204 at maximum may be formed into edge CSI subbands 1214, such as illustrated in the example of FIG. 12.

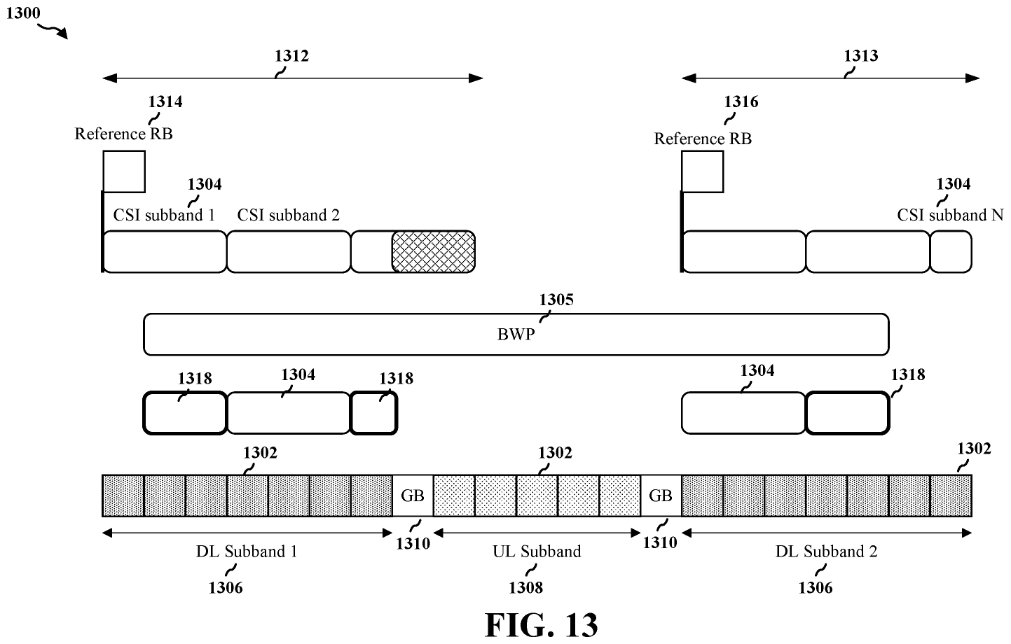

FIG. 13 illustrates an example 1300 of an allocation of frequency resources 1302 for SBFD. Similar to that of example 1000 in FIG. 10, CSI subbands 1304 in a BWP 1305 may be respectively defined from contiguous quantities of the frequency resources 1302, and multiple downlink subbands 1306, an uplink subband 1308 separating the downlink subbands 1306, and a guard band 1310 separating a respective downlink subband from the uplink subband 1308, may be allocated in SBFD. In this example, the CSI subbands 1304 associated with respective downlink subbands may be placed into groups 1312, 1313 and defined with respect to different reference resource blocks. For instance, a first one of the groups 1312 associated with one downlink subband may be defined with respect to reference resource block 1314 (the starting RB of the component carrier) as previously described, while a second one of the groups 1313 associated with the other downlink subband may be defined with respect to second reference resource block 1316 at the starting RB of that downlink subband. As a result, a lower maximum quantity (i.e., three) of edge CSI subbands 1318 may be formed due to application of the second reference resource block (the different reference starting point), such as illustrated in the second example of FIG. 13. Moreover, the reference resource block(s) applied may depend on the duplex mode of the slot associated with the CSI report. For instance, in a half-duplex slot or in a lower downlink subband of a full-duplex slot, reference resource block 1314 may be applied, and in an upper downlink subband of a full-duplex slot, second reference resource block 1316 may additionally be applied. Furthermore, the reference point for PDSCH precoding (in terms of PRB s) and FDRA (in terms of RBGs) for the upper downlink subband may be separately defined from the corresponding reference point for PDSCH precoding and FDRA, respectively, for the lower downlink subband. Thus, the first group of CSI subbands and the second group of CSI subbands may be separately aligned with their own respective PDSCH precoding and FDRA granularities.

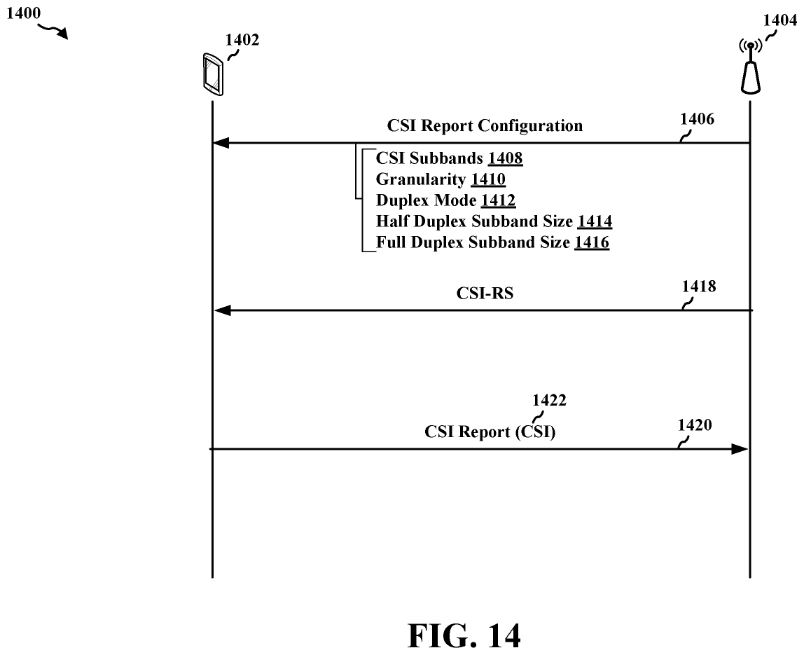

FIG. 14 is a diagram 1400 illustrating a call flow between a UE 1402 and a base station 1404. Initially, the base station 1404 may transmit a CSI report configuration 1406 to the UE 1402. The CSI report configuration 1406 may configure the UE 1402 to provide a CSI report including respective CSI for CSI subbands 1408. The CSI subbands 1408 may be associated with downlink subbands of a frequency band in a full duplex slot. The CSI report configuration 1406 may further indicate a granularity 1410 (or subband size) of the CSI subbands 1408. The granularity may be based, for example, on the size of a BWP including the CSI subbands, and on the size of a downlink subband associated with the CSI subbands. The CSI report configuration 1406 may indicate a duplex mode 1412 associated with the CSI report, for example, that the CSI report is to include CSI from a time instance corresponding to a half-duplex slot or a full-duplex slot. The CSI report configuration 1406 may additionally indicate a half-duplex subband size 1414 and a full duplex subband size 1416 for CSI subbands associated with different duplex modes. Following transmission of the CSI report configuration 1406, the base station 1404 may transmit CSI-RS 1418 to the UE in the full duplex slot, and after receiving the CSI-RS 1418, the UE may transmit a CSI report 1420 including CSI 1422 for the downlink subbands (and in some cases guard bands) in the full duplex slot. The CSI report may further lack CSI 1422 for the uplink subbands (and in some cases guard bands) in the full duplex slot.

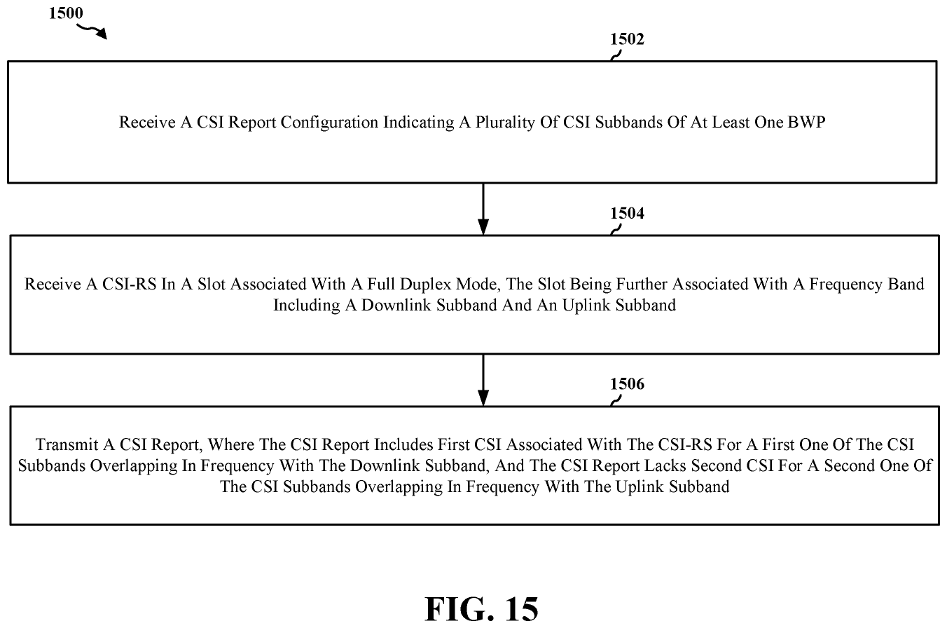

FIG. 15 is a flowchart 1500 of a method of wireless communication. The method may be performed by a UE (e.g., the UE 104, 350, 1402; the apparatus 1702). The method allows a UE to provide subband CSI reporting in full duplex slots.

At 1502, the UE may receive a CSI report configuration indicating a plurality of CSI subbands of at least one BWP. For example, 1502 may be performed by configuration component 1740. For instance, referring to FIG. 14, the UE 1402 may receive CSI report configuration 1406 from base station 1404. The CSI report configuration 1406 may indicate CSI subbands 1408 for subband CSI reporting (e.g., CSI subbands 608, 804, 904, 916, 1004, 1204, 1214, 1304, 1318). The CSI subbands 1408 may be of at least one BWP (e.g., BWP 604, 702, 708, 710, 1005, 1205, 1305).

At 1504, the UE may receive a CSI-RS in a slot associated with a full duplex mode, the slot being further associated with a frequency band including a downlink subband and an uplink subband. For example, 1504 may be performed by reference signal component 1742. For instance, referring to FIGS. 11 and 14, UE 1402 may receive CSI-RS 1418 from base station 1404 in ‘D+U’ slot 1108. This full duplex slot may be associated with a frequency band (e.g., frequency band 524, component carrier 606) including downlink subband 704, 806, 906, 1006, 1102, 1206, 1306 and uplink subband 706, 808, 908, 1008, 1104, 1208, 1308.

At 1506, the UE may transmit a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband. For example, 1506 may be performed by report component 1744. For instance, referring to FIG. 14, UE 1402 may transmit CSI report 1420 to base station 1404. The CSI report 1420 may include CSI 1422 (the first CSI in this example) associated with CSI-RS 1418 for CSI subbands 904, 1408 overlapping with downlink subband 704, 806, 906, 1006, 1102, 1206, 1306. The CSI report 1420 may lack CSI 1422 (the second CSI in this example) for CSI subbands 912, 1408 overlapping with uplink subband 706, 808, 908, 1008, 1104, 1208, 1308.

In one example, the second one of the CSI subbands (e.g., CSI subband 912 in example 911) overlaps in frequency with the uplink subband and a guard band between the downlink subband and the uplink subband.

In one example, the CSI report further lacks third CSI for a third one of the CSI subbands (e.g., CSI subband 912 in example 913) partially overlapping in frequency with the uplink subband or a guard band between the downlink subband and the uplink subband.

In one example, a third one of the CSI subbands (e.g., CSI subband 912 in example 914) partially overlaps in frequency with the uplink subband or a guard band between the downlink subband and the uplink subband, and the CSI report includes third CSI for a portion of the third one of the CSI subbands (e.g., edge CSI subband 916 in example 914) which overlaps with the downlink subband.

In one example, a third one of the CSI subbands (e.g., CSI subband 912 in example 915) partially overlaps in frequency with the uplink subband or a guard band between the downlink subband and the uplink subband, and the CSI report includes third CSI for a portion of the third one of the CSI subbands (e.g., edge CSI subband 916 in example 915) which overlaps with the downlink subband and the guard band.

In one example, a granularity of the CSI subbands (e.g., CSI subbands 1004 in example 1011) is based on a BWP size.

In one example, the at least one BWP includes a single active BWP (e.g., BWP 1005) in the frequency band, and the BWP size is of the single active BWP.

In one example, the at least one BWP includes a first active BWP (e.g., first BWP 708) and a second active BWP (e.g., second BWP 710) in the frequency band, a first group of the CSI subbands (e.g., CSI subbands 1004 in first group 1312) is within the first active BWP, a second group of the CSI subbands (e.g., CSI subbands 1004 in second group 1313) is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

In one example, a granularity of the CSI subbands (e.g., CSI subbands 1004) is further based on a downlink subband size.

In one example, the at least one BWP includes a single active BWP (e.g., BWP 1005) in the frequency band, the frequency band includes a second downlink subband (e.g., downlink subband 1006), and the granularity of the CSI subbands (e.g., the CSI subbands 1004 in example 1012) is based on an aggregate size of the downlink subband and the second downlink subband.

In one example, a granularity of the CSI subbands is based on a duplex mode of the CSI report (e.g., duplex mode 1412 or the association of the CSI report with CSI-RS in ‘D+U’ slot 1108).

In one example, the CSI report configuration indicates a half-duplex subband size (e.g., for subband CSI reporting in downlink slot 1106) and a full duplex subband size (e.g., for subband CSI reporting in ‘D+U’ slot 1108), and the granularity of the CSI subbands is the full duplex subband size based on the duplex mode being the full duplex mode (e.g., duplex mode 1412 or the association of the CSI report with CSI-RS in ‘D+U’ slot 1108).

In one example, an initial resource block for the CSI subbands (e.g., the starting point for CSI subbands 1204) is based on a reference resource block associated with a component carrier including the at least one BWP (e.g., reference resource block 1212).

In one example, the frequency band includes a second downlink subband, a first group of the CSI subbands (e.g., first group 1312) overlaps with the downlink subband, a second group of the CSI subbands (e.g., second group 1313) overlaps with the second downlink subband, a first initial resource block for the first group of the CSI subbands (e.g., the starting point for first group 1312) is based on a reference resource block associated with a component carrier including the at least one BWP (e.g., reference resource block 1314), and a second initial resource block (e.g., the starting point for second group 1313) for the second group of the CSI subbands is based on a different reference resource block (e.g., reference resource block 1316).

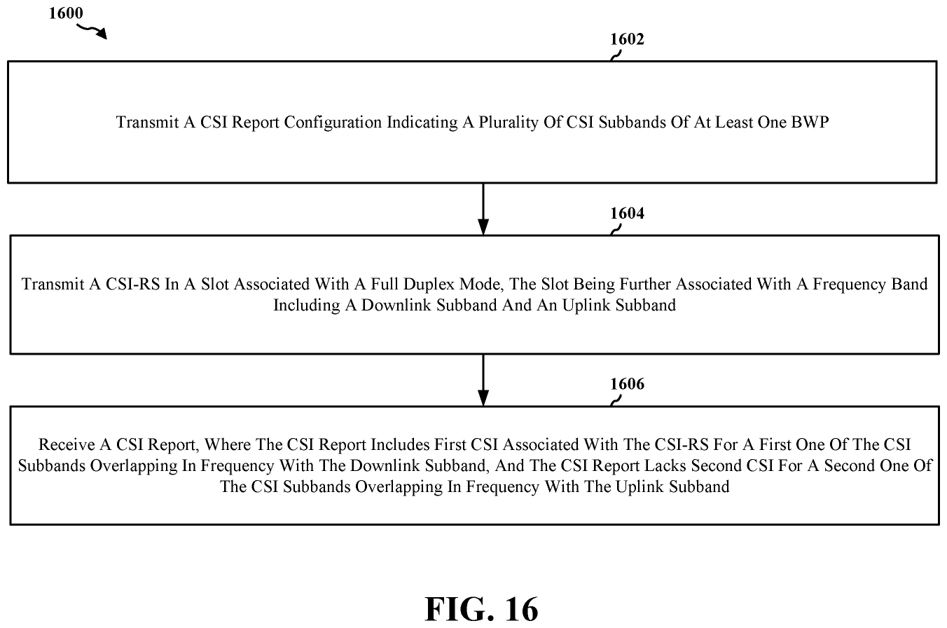

FIG. 16 is a flowchart 1600 of a method of wireless communication. The method may be performed by a network entity such as a base station (e.g., the base station 102/180, 310, 1404; disaggregated base station 181; the apparatus 1802). The method allows a base station to configure and receive subband CSI reports in full duplex slots.

At 1602, the base station may transmit a CSI report configuration indicating a plurality of CSI subbands of at least one BWP. For example, 1602 may be performed by configuration component 1840. For instance, referring to FIG. 14, the UE 1402 may receive CSI report configuration 1406 from base station 1404. The CSI report configuration 1406 may indicate CSI subbands 1408 for subband CSI reporting (e.g., CSI subbands 608, 804, 904, 916, 1004, 1204, 1214, 1304, 1318). The CSI subbands 1408 may be of at least one BWP (e.g., BWP 604, 702, 708, 710, 1005, 1205, 1305).

At 1604, the base station may transmit a CSI-RS in a slot associated with a full duplex mode, the slot being further associated with a frequency band including a downlink subband and an uplink subband. For example, 1604 may be performed by reference signal component 1842. For instance, referring to FIGS. 11 and 14, UE 1402 may receive CSI-RS 1418 from base station 1404 in ‘D+U’ slot 1108. This full duplex slot may be associated with a frequency band (e.g., frequency band 524, component carrier 606) including downlink subband 704, 806, 906, 1006, 1102, 1206, 1306 and uplink subband 706, 808, 908, 1008, 1104, 1208, 1308.

At 1606, the base station may receive a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband. For example, 1606 may be performed by report component 1844. For instance, referring to FIG. 14, UE 1402 may transmit CSI report 1420 to base station 1404. The CSI report 1420 may include CSI 1422 (the first CSI in this example) associated with CSI-RS 1418 for CSI subbands 1408 overlapping with downlink subband 704, 806, 906, 1006, 1102, 1206, 1306. The CSI report 1420 may lack CSI 1422 (the second CSI in this example) for CSI subbands 912, 1408 overlapping with uplink subband 706, 808, 908, 1008, 1104, 1208, 1308.

In one example, the second one of the CSI subbands (e.g., CSI subband 912 in example 911) overlaps in frequency with the uplink subband and a guard band between the downlink subband and the uplink subband.

In one example, the CSI report further lacks third CSI for a third one of the CSI subbands (e.g., CSI subband 912 in example 913) partially overlapping in frequency with the uplink subband or a guard band between the downlink subband and the uplink subband.

In one example, a third one of the CSI subbands (e.g., CSI subband 912 in example 914) partially overlaps in frequency with the uplink subband or a guard band between the downlink subband and the uplink subband, and the CSI report includes third CSI for a portion of the third one of the CSI subbands (e.g., edge CSI subband 916 in example 914) which overlaps with the downlink subband.

In one example, a third one of the CSI subbands (e.g., CSI subband 912 in example 915) partially overlaps in frequency with the uplink subband or a guard band between the downlink subband and the uplink subband, and the CSI report includes third CSI for a portion of the third one of the CSI subbands (e.g., edge CSI subband 916 in example 915) which overlaps with the downlink subband and the guard band.

In one example, a granularity of the CSI subbands (e.g., CSI subbands 1004 in example 1011) is based on a BWP size.

In one example, the at least one BWP includes a single active BWP (e.g., BWP 1005) in the frequency band, and the BWP size is of the single active BWP.

In one example, the at least one BWP includes a first active BWP (e.g., first BWP 708) and a second active BWP (e.g., second BWP 710) in the frequency band, a first group of the CSI subbands (e.g., CSI subbands 1004 in first group 1312) is within the first active BWP, a second group of the CSI subbands (e.g., CSI subbands 1004 in second group 1313) is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

In one example, a granularity of the CSI subbands (e.g., CSI subbands 1004) is further based on a downlink subband size.

In one example, the at least one BWP includes a single active BWP (e.g., BWP 1005) in the frequency band, the frequency band includes a second downlink subband (e.g., downlink subband 1006), and the granularity of the CSI subbands (e.g., the CSI subbands 1004 in example 1012) is based on an aggregate size of the downlink subband and the second downlink subband.

In one example, a granularity of the CSI subbands is based on a duplex mode of the CSI report (e.g., duplex mode 1412 or the association of the CSI report with CSI-RS in ‘D+U’ slot 1108).

In one example, the CSI report configuration indicates a half-duplex subband size (e.g., for subband CSI reporting in downlink slot 1106) and a full duplex subband size (e.g., for subband CSI reporting in ‘D+U’ slot 1108), and the granularity of the CSI subbands is the full duplex subband size based on the duplex mode being the full duplex mode (e.g., duplex mode 1412 or the association of the CSI report with CSI-RS in ‘D+U’ slot 1108).

In one example, an initial resource block for the CSI subbands (e.g., the starting point for CSI subbands 1204) is based on a reference resource block associated with a component carrier including the at least one BWP (e.g., reference resource block 1212).

In one example, the frequency band includes a second downlink subband, a first group of the CSI subbands (e.g., first group 1312) overlaps with the downlink subband, a second group of the CSI subbands (e.g., second group 1313) overlaps with the second downlink subband, a first initial resource block for the first group of the CSI subbands (e.g., the starting point for first group 1312) is based on a reference resource block associated with a component carrier including the at least one BWP (e.g., reference resource block 1314), and a second initial resource block (e.g., the starting point for second group 1313) for the second group of the CSI subbands is based on a different reference resource block (e.g., reference resource block 1316).

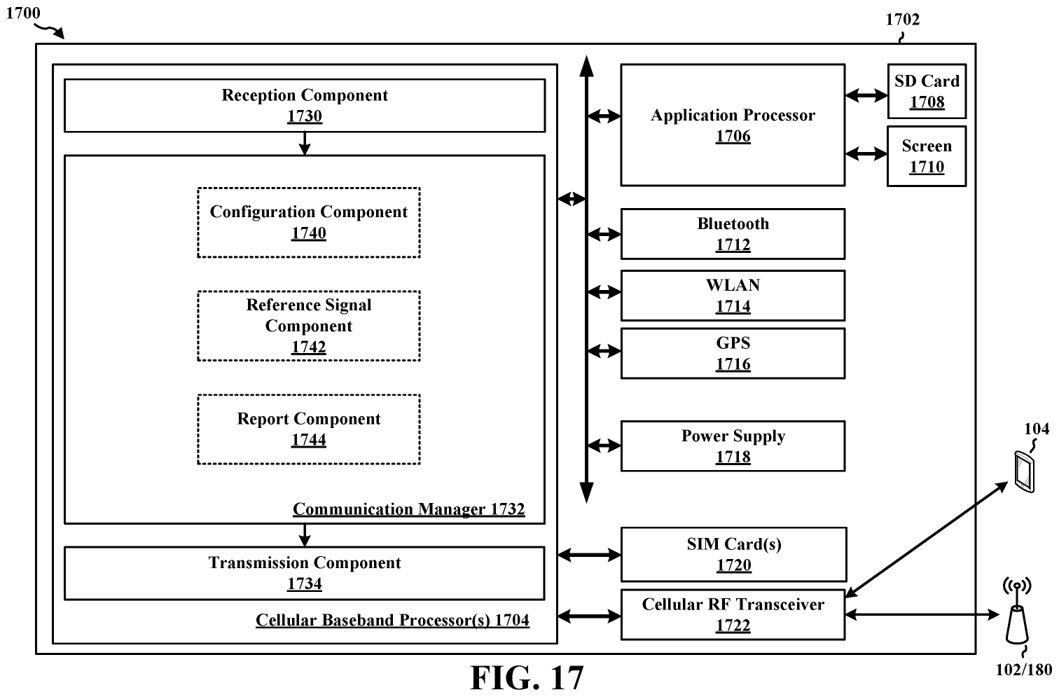

FIG. 17 is a diagram 1700 illustrating an example of a hardware implementation for an apparatus 1702. The apparatus 1702 is a UE and includes one or more cellular baseband processors 1704 (also referred to as a modem) coupled to a cellular RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The one or more cellular baseband processors 1704 communicate through the cellular RF transceiver 1722 with the UE 104 and/or BS 102/180/disaggregated base station 181. The one or more cellular baseband processors 1704 may each include a computer-readable medium/one or more memories. The computer-readable medium/one or more memories may be non-transitory. The one or more cellular baseband processors 1704 are responsible for general processing, including the execution of software stored on the computer-readable medium/one or more memories individually or in combination. The software, when executed by the one or more cellular baseband processors 1704, causes the one or more cellular baseband processors 1704 to, individually or in combination, perform the various functions described supra. The computer-readable medium/one or more memories may also be used individually or in combination for storing data that is manipulated by the one or more cellular baseband processors 1704 when executing software. The one or more cellular baseband processors 1704 individually or in combination further include a reception component 1730, a communication manager 1732, and a transmission component 1734. The communication manager 1732 includes the one or more illustrated components. The components within the communication manager 1732 may be stored in the computer-readable medium/one or more memories and/or configured as hardware within the one or more cellular baseband processors 1704. The one or more cellular baseband processors 1704 may be components of the UE 350 and may individually or in combination include the one or more memories 360 and/or at least one of the one or more TX processors 368, at least one of the one or more RX processors 356, and at least one of the one or more controllers/processors 359. In one configuration, the apparatus 1702 may be a modem chip and include just the one or more baseband processors 1704, and in another configuration, the apparatus 1702 may be the entire UE (e.g., see 350 of FIG. 3) and include the aforediscussed additional modules of the apparatus 1702.

The communication manager 1732 includes a configuration component 1740 that is configured to receive a CSI report configuration indicating a plurality of CSI subbands of at least one BWP, e.g., as described in connection with 1502.

The communication manager 1732 includes a reference signal component 1742 that is configured to receive a CSI-RS in a slot associated with a full duplex mode, the slot being further associated with a frequency band including a downlink subband and an uplink subband, e.g., as described in connection with 1504.

The communication manager 1732 includes a report component 1744 that is configured to transmit a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband, e.g., as described in connection with 1506.

The apparatus may include additional components that perform each of the blocks of the algorithm in the aforementioned flowcharts of FIG. 15. As such, each block in the aforementioned flowcharts of FIG. 15 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1702, and in particular one or more cellular baseband processors 1704, includes means for receiving a CSI report configuration indicating a plurality of CSI subbands of at least one BWP, where the means for receiving is further configured to receive a CSI-RS in a slot associated with a full duplex mode, the slot being further associated with a frequency band including a downlink subband and an uplink subband, and means for transmitting a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

The aforementioned means may be one or more of the aforementioned components of the apparatus 1702 configured to perform the functions recited by the aforementioned means. As described supra, the apparatus 1702 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

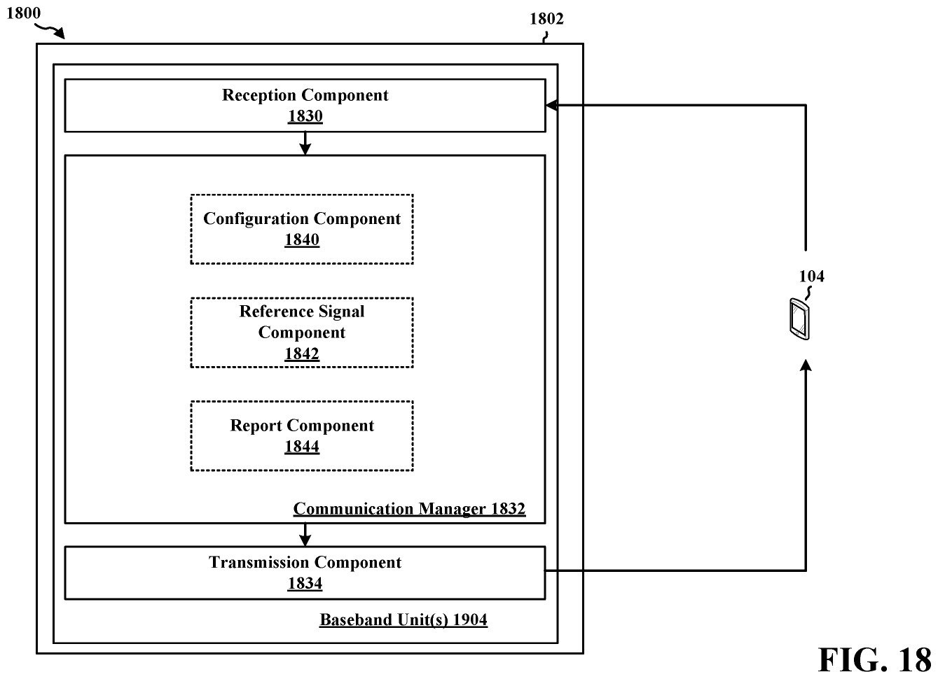

FIG. 18 is a diagram 1800 illustrating an example of a hardware implementation for an apparatus 1802. The apparatus 1802 is a network entity such as a base station and includes one or more baseband units 1804. The one or more baseband units 1804 communicate through a cellular RF transceiver with the UE 104. The one or more baseband units 1804 may each include a computer-readable medium/one or more memories. The computer-readable medium/one or more memories may be non-transitory. The one or more baseband units 1804 are responsible for general processing, including the execution of software stored on the computer-readable medium/one or more memories individually or in combination. The software, when executed by the one or more baseband units 1804, causes the one or more baseband units 1804 to, individually or in combination, perform the various functions described supra. The computer-readable medium/one or more memories may also be used individually or in combination for storing data that is manipulated by the one or more baseband units 1804 when executing software. The one or more baseband units 1804 individually or in combination further include a reception component 1830, a communication manager 1832, and a transmission component 1834. The communication manager 1832 includes the one or more illustrated components. The components within the communication manager 1832 may be stored in the computer-readable medium/one or more memories and/or configured as hardware within the one or more baseband units 1804. The one or more baseband units 1804 may be components of the BS 310 and may individually or in combination include the one or more memories 376 and/or at least one of the one or more TX processors 316, at least one of the one or more RX processors 370, and at least one of the one or more controllers/processors 375.

The communication manager 1832 includes a configuration component 1840 that is configured to transmit a CSI report configuration indicating a plurality of CSI subbands of at least one BWP, e.g., as described in connection with 1602.

The communication manager 1832 includes a reference signal component 1842 that is configured to transmit a CSI-RS in a slot associated with a full duplex mode, the slot being further associated with a frequency band including a downlink subband and an uplink subband, e.g., as described in connection with 1604.

The communication manager 1832 includes a report component 1844 that is configured to receive a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband, e.g., as described in connection with 1606.

The apparatus may include additional components that perform each of the blocks of the algorithm in the aforementioned flowchart of FIG. 16. As such, each block in the aforementioned flowcharts of FIG. 16 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1802, and in particular the one or more baseband units 1804, includes means for transmitting a CSI report configuration indicating a plurality of CSI subbands of at least one BWP, where the means for transmitting is further configured to transmit a CSI-RS in a slot associated with a full duplex mode, the slot being further associated with a frequency band including a downlink subband and an uplink subband, and means for receiving a CSI report, where the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

The aforementioned means may be one or more of the aforementioned components of the apparatus 1802 configured to perform the functions recited by the aforementioned means. As described supra, the apparatus 1802 may include the one or more TX Processors 316, the one or more RX Processors 370, and the one or more controllers/processors 375. As such, in one configuration, the aforementioned means may be at least one of the one or more TX Processors 316, at least one of the one or more RX Processors 356, or at least one of the one or more controllers/processors 359, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Example 1 is an apparatus for wireless communication, comprising: one or more memories; and one or more processors each communicatively coupled with at least one of the one or more memories, the one or more processors, individually or in any combination, operable to cause the apparatus to: receive a channel state information (CSI) report configuration indicating a plurality of CSI subbands of at least one bandwidth part (BWP); receive a CSI reference signal (CSI-RS) in a slot associated with a full duplex mode, the slot being further associated with a frequency band including a downlink subband and an uplink subband; and transmit a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 2 is the apparatus of Example 1, wherein the second one of the CSI subbands overlaps in frequency with the uplink subband and a guard band between the downlink subband and the uplink subband.

Example 3 is the apparatus of Example 1, wherein the CSI report further lacks third CSI for a third one of the CSI subbands partially overlapping in frequency with the uplink subband or a guard band between the downlink subband and the uplink subband.

Example 4 is the apparatus of Example 1, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

Example 5 is the apparatus of Example 1, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

Example 6 is the apparatus of any of Examples 1 to 5, wherein a granularity of the CSI subbands is based on a BWP size.

Example 7 is the apparatus of Example 6, wherein the at least one BWP includes a single active BWP in the frequency band, and the BWP size is of the single active BWP.

Example 8 is the apparatus of Example 6, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

Example 9 is the apparatus of Example 6, wherein the granularity of the CSI subbands is further based on a downlink subband size.

Example 10 is the apparatus of Example 9, wherein the at least one BWP includes a single active BWP in the frequency band, the frequency band includes a second downlink subband, and the granularity of the CSI subbands is based on an aggregate size of the downlink subband and the second downlink subband.

Example 11 is the apparatus of any of Examples 1 to 10, wherein a granularity of the CSI subbands is based on a duplex mode of the CSI report.

Example 12 is the apparatus of Example 11, wherein the CSI report configuration indicates a half-duplex subband size and a full duplex subband size, and the granularity of the CSI subbands is the full duplex subband size based on the duplex mode being the full duplex mode.

Example 13 is the apparatus of any of Examples 1 to 12, wherein an initial resource block for the CSI subbands is based on a reference resource block associated with a component carrier including the at least one BWP.

Example 14 is the apparatus of any of Examples 1 to 12, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

Example 15 is an apparatus for wireless communication, comprising: one or more memories; and one or more processors each communicatively coupled with at least one of the one or more memories, the one or more processors, individually or in any combination, operable to cause the apparatus to: transmit a channel state information (CSI) report configuration indicating a plurality of CSI subbands of at least one bandwidth part (BWP); transmit a CSI reference signal (CSI-RS) in a slot associated with a full duplex mode, the slot being further associated with a frequency band including a downlink subband and an uplink subband; and receive a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 16 is the apparatus of Example 15, wherein the second one of the CSI subbands overlaps in frequency with the uplink subband and a guard band between the downlink subband and the uplink subband.

Example 17 is the apparatus of Example 15, wherein the CSI report further lacks third CSI for a third one of the CSI subbands partially overlapping in frequency with the uplink subband or a guard band between the downlink subband and the uplink subband.

Example 18 is the apparatus of Example 15, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

Example 19 is the apparatus of Example 15, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

Example 20 is the apparatus of any of Examples 15 to 19, wherein a granularity of the CSI subbands is based on a BWP size.

Example 21 is the apparatus of Example 20, wherein the at least one BWP includes a single active BWP in the frequency band, and the BWP size is of the single active BWP.

Example 22 is the apparatus of Example 20, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

Example 23 is the apparatus of Example 20, wherein the granularity of the CSI subbands is further based on a downlink subband size.

Example 24 is the apparatus of Example 23, wherein the at least one BWP includes a single active BWP in the frequency band, the frequency band includes a second downlink subband, and the granularity of the CSI subbands is based on an aggregate size of the downlink subband and the second downlink subband.

Example 25 is the apparatus of any of Examples 15 to 24, wherein a granularity of the CSI subbands is based on a duplex mode of the CSI report.

Example 26 is the apparatus of Example 25, wherein the CSI report configuration indicates a half-duplex subband size and a full duplex subband size, and the granularity of the CSI subbands is the full duplex subband size based on the duplex mode being the full duplex mode.

Example 27 is the apparatus of any of Examples 15 to 26, wherein an initial resource block for the CSI subbands is based on a reference resource block associated with a component carrier including the at least one BWP.

Example 28 is the apparatus of any of Examples 15 to 26, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

Example 29 is a method of wireless communication at a user equipment (UE), comprising: receiving a channel state information (CSI) report configuration indicating a plurality of CSI subbands of at least one bandwidth part (BWP); receiving a CSI reference signal (CSI-RS) in a slot associated with a full duplex mode, the slot being further associated with a frequency band including a downlink subband and an uplink subband; and transmitting a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 30 is the method of Example 29, wherein the second one of the CSI subbands overlaps in frequency with the uplink subband and a guard band between the downlink subband and the uplink subband.

Example 31 is the method of Example 29, wherein the CSI report further lacks third CSI for a third one of the CSI subbands partially overlapping in frequency with the uplink subband or a guard band between the downlink subband and the uplink subband.

Example 32 is the method of Example 29, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

Example 33 is the method of Example 29, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

Example 34 is the method of any of Examples 29 to 33, wherein a granularity of the CSI subbands is based on a BWP size.

Example 35 is the method of Example 34, wherein the at least one BWP includes a single active BWP in the frequency band, and the BWP size is of the single active BWP.

Example 36 is the method of Example 34, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

Example 37 is the method of Example 34, wherein the granularity of the CSI subbands is further based on a downlink subband size.

Example 38 is the method of Example 37, wherein the at least one BWP includes a single active BWP in the frequency band, the frequency band includes a second downlink subband, and the granularity of the CSI subbands is based on an aggregate size of the downlink subband and the second downlink subband.

Example 39 is the method of any of Examples 29 to 38, wherein a granularity of the CSI subbands is based on a duplex mode of the CSI report.

Example 40 is the method of Example 39, wherein the CSI report configuration indicates a half-duplex subband size and a full duplex subband size, and the granularity of the CSI subbands is the full duplex subband size based on the duplex mode being the full duplex mode.

Example 41 is the method of any of Examples 29 to 40, wherein an initial resource block for the CSI subbands is based on a reference resource block associated with a component carrier including the at least one BWP.

Example 42 is the method of any of Examples 29 to 40, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

Example 43 is a method of wireless communication at a network entity, comprising: transmitting a channel state information (CSI) report configuration indicating a plurality of CSI subbands of at least one bandwidth part (BWP); transmitting a CSI reference signal (CSI-RS) in a slot associated with a full duplex mode, the slot being further associated with a frequency band including a downlink subband and an uplink subband; and receiving a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 44 is the method of Example 43, wherein the second one of the CSI subbands overlaps in frequency with the uplink subband and a guard band between the downlink subband and the uplink subband.

Example 45 is the method of Example 43, wherein the CSI report further lacks third CSI for a third one of the CSI subbands partially overlapping in frequency with the uplink subband or a guard band between the downlink subband and the uplink subband.

Example 46 is the method of Example 43, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

Example 47 is the method of Example 43, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

Example 48 is the method of any of Examples 43 to 47, wherein a granularity of the CSI subbands is based on a BWP size.

Example 49 is the method of Example 48, wherein the at least one BWP includes a single active BWP in the frequency band, and the BWP size is of the single active BWP.

Example 50 is the method of Example 48, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

Example 51 is the method of Example 48, wherein the granularity of the CSI subbands is further based on a downlink subband size.

Example 52 is the method of Example 51, wherein the at least one BWP includes a single active BWP in the frequency band, the frequency band includes a second downlink subband, and the granularity of the CSI subbands is based on an aggregate size of the downlink subband and the second downlink subband.

Example 53 is the method of any of Examples 43 to 52, wherein a granularity of the CSI subbands is based on a duplex mode of the CSI report.

Example 54 is the method of Example 53, wherein the CSI report configuration indicates a half-duplex subband size and a full duplex subband size, and the granularity of the CSI subbands is the full duplex subband size based on the duplex mode being the full duplex mode.

Example 55 is the method of any of Examples 43 to 54, wherein an initial resource block for the CSI subbands is based on a reference resource block associated with a component carrier including the at least one BWP.

Example 56 is the method of any of Examples 43 to 54, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

Example 57 is an apparatus for wireless communication, comprising: means for receiving a channel state information (CSI) report configuration indicating a plurality of CSI subbands of at least one bandwidth part (BWP); wherein the means for receiving is further configured to receive a CSI reference signal (CSI-RS) in a slot associated with a full duplex mode, the slot being further associated with a frequency band including a downlink subband and an uplink subband; and means for transmitting a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 58 is an apparatus for wireless communication, comprising: means for transmitting a channel state information (CSI) report configuration indicating a plurality of CSI subbands of at least one bandwidth part (BWP); wherein the means for transmitting is further configured to receive a CSI reference signal (CSI-RS) in a slot associated with a full duplex mode, the slot being further associated with a frequency band including a downlink subband and an uplink subband; and means for receiving a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 59 is a non-transitory, computer-readable medium storing computer executable code, the code when executed by a processor cause the processor to: receive a channel state information (CSI) report configuration indicating a plurality of CSI subbands of at least one bandwidth part (BWP); receive a CSI reference signal (CSI-RS) in a slot associated with a full duplex mode, the slot being further associated with a frequency band including a downlink subband and an uplink subband; and transmit a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

Example 60 is a non-transitory, computer-readable medium storing computer executable code, the code when executed by a processor cause the processor to: transmit a channel state information (CSI) report configuration indicating a plurality of CSI subbands of at least one bandwidth part (BWP); transmit a CSI reference signal (CSI-RS) in a slot associated with a full duplex mode, the slot being further associated with a frequency band including a downlink subband and an uplink subband; and receive a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive a channel state information (CSI) report configuration indicating a plurality of CSI subbands of at least one bandwidth part (BWP);
receive a CSI reference signal (CSI-RS) in a slot associated with a full duplex mode, the slot being further associated with a frequency band including a downlink subband and an uplink subband; and
transmit a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

2. The apparatus of claim 1, wherein the second one of the CSI subbands overlaps in frequency with the uplink subband and a guard band between the downlink subband and the uplink subband.

3. The apparatus of claim 1, wherein the CSI report further lacks third CSI for a third one of the CSI subbands partially overlapping in frequency with the uplink subband or a guard band between the downlink subband and the uplink subband.

4. The apparatus of claim 1, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

5. The apparatus of claim 1, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

6. The apparatus of claim 1, wherein a granularity of the CSI subbands is based on a BWP size.

7. The apparatus of claim 6, wherein the at least one BWP includes a single active BWP in the frequency band, and the BWP size is of the single active BWP.

8. The apparatus of claim 6, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

9. The apparatus of claim 6, wherein the granularity of the CSI subbands is further based on a downlink subband size.

10. The apparatus of claim 9, wherein the at least one BWP includes a single active BWP in the frequency band, the frequency band includes a second downlink subband, and the granularity of the CSI subbands is based on an aggregate size of the downlink subband and the second downlink subband.

11. The apparatus of claim 1, wherein a granularity of the CSI subbands is based on a duplex mode of the CSI report.

12. The apparatus of claim 11, wherein the CSI report configuration indicates a half-duplex subband size and a full duplex subband size, and the granularity of the CSI subbands is the full duplex subband size based on the duplex mode being the full duplex mode.

13. The apparatus of claim 1, wherein an initial resource block for the CSI subbands is based on a reference resource block associated with a component carrier including the at least one BWP.

14. The apparatus of claim 1, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

15. An apparatus for wireless communication, comprising:
one or more memories; and
one or more processors each communicatively coupled with at least one of the one or more memories, the one or more processors, individually or in any combination, operable to cause the apparatus to:
transmit a channel state information (CSI) report configuration indicating a plurality of CSI subbands of at least one bandwidth part (BWP);
transmit a CSI reference signal (CSI-RS) in a slot associated with a full duplex mode, the slot being further associated with a frequency band including a downlink subband and an uplink subband; and
receive a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

16. The apparatus of claim 15, wherein the second one of the CSI subbands overlaps in frequency with the uplink subband and a guard band between the downlink subband and the uplink subband.

17. The apparatus of claim 15, wherein the CSI report further lacks third CSI for a third one of the CSI subbands partially overlapping in frequency with the uplink subband or a guard band between the downlink subband and the uplink subband.

18. The apparatus of claim 15, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband.

19. The apparatus of claim 15, wherein a third one of the CSI subbands partially overlaps in frequency with the uplink subband or a guard band between the downlink subband and the uplink subband, and the CSI report includes third CSI for a portion of the third one of the CSI subbands which overlaps with the downlink subband and the guard band.

20. The apparatus of claim 15, wherein a granularity of the CSI subbands is based on a BWP size.

21. The apparatus of claim 20, wherein the at least one BWP includes a single active BWP in the frequency band, and the BWP size is of the single active BWP.

22. The apparatus of claim 20, wherein the at least one BWP includes a first active BWP and a second active BWP in the frequency band, a first group of the CSI subbands is within the first active BWP, a second group of the CSI subbands is within the second active BWP, the granularity of the first group of the CSI subbands is based on a first BWP size of the first active BWP, the granularity of the second group of the CSI subbands is based on a second BWP size of the second active BWP, and the second BWP size is different than the first BWP size.

23. The apparatus of claim 20, wherein the granularity of the CSI subbands is further based on a downlink subband size.

24. The apparatus of claim 23, wherein the at least one BWP includes a single active BWP in the frequency band, the frequency band includes a second downlink subband, and the granularity of the CSI subbands is based on an aggregate size of the downlink subband and the second downlink subband.

25. The apparatus of claim 15, wherein a granularity of the CSI subbands is based on a duplex mode of the CSI report.

26. The apparatus of claim 25, wherein the CSI report configuration indicates a half-duplex subband size and a full duplex subband size, and the granularity of the CSI subbands is the full duplex subband size based on the duplex mode being the full duplex mode.

27. The apparatus of claim 15, wherein an initial resource block for the CSI subbands is based on a reference resource block associated with a component carrier including the at least one BWP.

28. The apparatus of claim 15, wherein the frequency band includes a second downlink subband, a first group of the CSI subbands overlaps with the downlink subband, a second group of the CSI subbands overlaps with the second downlink subband, a first initial resource block for the first group of the CSI subbands is based on a reference resource block associated with a component carrier including the at least one BWP, and a second initial resource block for the second group of the CSI subbands is based on a different reference resource block.

29. A method of wireless communication at a user equipment (UE), comprising:
receiving a channel state information (CSI) report configuration indicating a plurality of CSI subbands of at least one bandwidth part (BWP);
receiving a CSI reference signal (CSI-RS) in a slot associated with a full duplex mode, the slot being further associated with a frequency band including a downlink subband and an uplink subband; and
transmitting a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.

30. A method of wireless communication at a network entity, comprising:
transmitting a channel state information (CSI) report configuration indicating a plurality of CSI subbands of at least one bandwidth part (BWP);
transmitting a CSI reference signal (CSI-RS) in a slot associated with a full duplex mode, the slot being further associated with a frequency band including a downlink subband and an uplink subband; and
receiving a CSI report, wherein the CSI report includes first CSI associated with the CSI-RS for a first one of the CSI subbands overlapping in frequency with the downlink subband, and the CSI report lacks second CSI for a second one of the CSI subbands overlapping in frequency with the uplink subband.
